(19) United States
(12) Patent Application Publication
(10) Pub. No.: US 2024/0416969 A1
(43) Pub. Date: Dec. 19, 2024

(54) SELF-DRIVING-BASED VEHICLE NAVIGATION METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Jingbo FAN, Shenzhen (CN)

(21) Appl. No.: 18/816,778

(22) Filed: Aug. 27, 2024

Related U.S. Application Data
(63) Continuation of application No. PCT/CN2023/094156, filed on May 15, 2023.

(30) Foreign Application Priority Data
Aug. 1, 2022 (CN) 202210920055.9

(51) Int. Cl. B60W 60/00; B60W 50/14

(52) U.S. Cl. CPC B60W 60/0053; B60W 50/14; B60W 2050/146

(57) ABSTRACT

A vehicle navigation method includes displaying an assisted driving interface including self-driving information of a vehicle in response to the vehicle being in a self-driving state, and in response to a distance between a location of the vehicle and a state switching point being shorter than a distance threshold, outputting takeover prompt information based on the assisted driving interface. The state switching point is a location on a road at which the vehicle is automatically switched from the self-driving state to a manual driving state. The method further includes displaying a navigation map in response to the vehicle being switched from the self-driving state to the manual driving state.

### CROSS-REFERENCE TO RELATED APPLICATIONS

This application is a continuation of International Application No. PCT/CN2023/094156, filed on May 15, 2023, which claims priority to Chinese Patent Application No. 202210920055.9 filed on Aug. 1, 2022, the entire contents of both of which are incorporated by reference.

### FIELD OF THE TECHNOLOGY

This application relates to the field of intelligent transportation technologies, and in particular, to a self-driving-based vehicle navigation method and apparatus, a device, a storage medium, and a program product.

### BACKGROUND OF THE DISCLOSURE

With the rapid development of computer technologies and communication technologies, vehicle navigation has been widely applied to people's daily transportation. Vehicle self-driving navigation is one of the most important applications in the field of vehicle navigation, and a vehicle can automatically travel to a destination based on a self-driving navigation route without manual operations by a user.

In the related art, when a vehicle is switched from a self-driving state to a manual driving state, the vehicle no longer displays a navigation map. A driving object learns a small amount of information from a guidance panel in the vehicle, and the utilization of hardware display resources is low. As a result, the vehicle tends to miss a critical intersection and travel on an incorrect route.

### SUMMARY

In accordance with the disclosure, there is provided a vehicle navigation method performed by an electronic device and including displaying an assisted driving interface including self-driving information of a vehicle in response to the vehicle being in a self-driving state, and in response to a distance between a location of the vehicle and a state switching point being shorter than a distance threshold, outputting takeover prompt information based on the assisted driving interface. The state switching point is a location on a road at which the vehicle is automatically switched from the self-driving state to a manual driving state. The method further includes displaying a navigation map in response to the vehicle being switched from the self-driving state to the manual driving state.

Also in accordance with the disclosure, there is provided an electronic device including at least one memory storing one or more executable instructions, and at least one processor configured to execute the one or more executable instructions to display an assisted driving interface including self-driving information of a vehicle in response to the vehicle being in a self-driving state, and in response to a distance between a location of the vehicle and a state switching point being shorter than a distance threshold, output takeover prompt information based on the assisted driving interface. The state switching point is a location on a road at which the vehicle is automatically switched from the self-driving state to a manual driving state. The at least one processor is configured to execute the one or more executable instructions to display a navigation map in response to the vehicle being switched from the self-driving state to the manual driving state.

Also in accordance with the disclosure, there is provided a non-transitory computer-readable storage medium storing one or more computer executable instructions that, when executed by at least one processor, cause the at least one processor to display an assisted driving interface including self-driving information of a vehicle in response to the vehicle being in a self-driving state, and in response to a distance between a location of the vehicle and a state switching point being shorter than a distance threshold, output takeover prompt information based on the assisted driving interface. The state switching point is a location on a road at which the vehicle is automatically switched from the self-driving state to a manual driving state. The one or more computer executable instructions, when executed by at least one processor, further cause the at least one processor to display a navigation map in response to the vehicle being switched from the self-driving state to the manual driving state.

### BRIEF DESCRIPTION OF THE DRAWINGS

FIG. 1 is a schematic structural diagram of an architecture of a self-driving-based vehicle navigation system according to an embodiment of this application.

FIG. 2 is a schematic structural diagram of a self-driving-based vehicle navigation apparatus according to an embodiment of this application.

FIG. 3 is a schematic flowchart of a self-driving-based vehicle navigation method according to an embodiment of this application.

FIG. 4 is a schematic interface diagram of an assisted driving interface according to an embodiment of this application.

FIG. 5 is a schematic interface diagram of takeover prompt information according to an embodiment of this application.

FIG. 6A and FIG. 6B are schematic interface diagrams of a navigation route in an assisted driving interface according to an embodiment of this application.

FIG. 7 is a schematic interface diagram of a navigation floating layer in an assisted driving interface according to an embodiment of this application.

FIG. 8 is a schematic interface diagram of a floating window in an assisted driving interface according to an embodiment of this application.

FIG. 9 is a schematic interface diagram of takeover guidance information in an assisted driving interface according to an embodiment of this application.

FIG. 10 is a schematic interface diagram of a driving status icon according to an embodiment of this application.

FIG. 11 is a schematic interface diagram of operation indication information according to an embodiment of this application.

FIG. 12 is a schematic interface diagram of state switching auxiliary information according to an embodiment of this application.

FIG. 13 is a schematic interface diagram of a traveling path according to an embodiment of this application.

FIG. 14 is a schematic interface diagram of takeover alarm information according to an embodiment of this application.

FIG. 15A to FIG. 15C are schematic interface diagrams of a traveling progress bar according to an embodiment of this application.

FIG. 16 is a schematic interface diagram of a map mode switching control according to an embodiment of this application.

FIG. 17 is a schematic interface diagram of state switching prompt information according to an embodiment of this application.

FIG. 18 is a schematic interface diagram of a second state switching point according to an embodiment of this application.

FIG. 19 is a schematic interface diagram of a distance between a location of a vehicle and a second state switching point according to an embodiment of this application.

FIG. 20A and FIG. 20B are schematic effect diagrams of a self-driving-based vehicle navigation method according to an embodiment of this application.

FIG. 21 is a schematic principle diagram of a self-driving-based vehicle navigation method according to an embodiment of this application.

### DESCRIPTION OF EMBODIMENTS

To make the objectives, technical solutions, and advantages of this application clearer, the following describes this application in detail with reference to the accompanying drawings. The described embodiments are not to be considered as a limitation to this application. All other embodiments obtained by a person of ordinary skill in the art without creative efforts shall fall within the scope of protection of this application.

In the following descriptions, related “some embodiments” describe a subset of all possible embodiments. However, the “some embodiments” may be the same subset or different subsets of all the possible embodiments, and may be combined with each other without conflict.

In the following descriptions, the related term “first/second/third” is merely intended to distinguish between similar objects rather than represent a particular sequence of the objects. A particular sequence or a chronological order indicated by “first/second/third” may be changed, so that the embodiments of this application described herein can be implemented in a sequence other than the sequence illustrated or described herein.

Unless otherwise defined, meanings of all technical and scientific terms used in this specification are the same as those usually understood by a person skilled in the art to which this application belongs. Terms used herein are merely intended to describe the specific embodiments of this application, but are not intended to limit this application.

Before the embodiments of this application are described in detail, a description is made on terms involved in the embodiments of this application, and the terms involved in the embodiments of this application are applicable to the following explanations.
(1) “In response to” is configured for representing a condition or state on which a performed operation depends. When the condition or state on which the performed operation depends is met, one or more performed operations may be performed in real time, or may be performed after a set delay. Unless particularly described, a plurality of performed operations are not limited to an execution sequence.
(2) Self-driving is a function of providing guidance and decision making for a vehicle traveling task and enabling a vehicle to complete safe traveling instead of using the manipulation behavior of a driver depending on the collaboration of artificial intelligence, visual computation, radar, an image acquisition apparatus, a global positioning system, and the like without physical driving operations by the driver.
(3) A self-driving blind spot is an area that does not support self-driving in an electronic map, for example, a toll station, a ramp, or another area through which a vehicle cannot pass independently without operations by a driver in a self-driving state.
(4) A navigation route is a route calculated according to a set navigation starting point and a navigation end point, to be specific, a route including the navigation starting point, a series of roads, and the final navigation end point. In the embodiments of this application, the navigation route may include a recommended traveling lane of each road that needs to be traveled, or lanes may not be differentiated. Certainly, lanes may be differentiated for some roads, and lanes may not be differentiated for some roads.
(5) An assisted driving interface is an interface displayed by a corresponding in-vehicle terminal when a vehicle is in a self-driving state (including a semi-self-driving state and a full-self-driving state). The interface is configured for displaying self-driving information of the vehicle in the self-driving state in real time, for example, a lane in which the vehicle is located, a speed of the vehicle, a self-driving duration of the vehicle in a current traveling process of the vehicle.

In a process of implementing the embodiments of this application, the applicant finds that the related art at least has the following problems.

In the related art, most cases of a road ahead no longer supporting self-driving occur in a scenario in which a driving object is to drive out of a high-precision map area, i.e., a vehicle is to enter a ramp, or the like, and after taking over the vehicle, a user needs to perform an operation of changing to a right lane, entering a ramp, or the like immediately. Through only information from a guidance panel in the related art, the driving object cannot clearly know a location at which a next action is to take place after taking over the vehicle, and as a result the vehicle tends to miss a critical intersection and travel on an incorrect route. In the related art, the driving object is guided through the information from the guidance panel. Therefore, when the vehicle is switched from a self-driving state to a manual driving state, after the driving object takes over the vehicle, the vehicle cannot travel according to a correct route due to insufficient information from the guidance panel, resulting in poor guidance performance of vehicle navigation.

Embodiments of this application provide a self-driving-based vehicle navigation method and apparatus, an electronic device, a computer-readable storage medium, and a computer program product, which can effectively improve the guidance performance in self-driving and the utilization of hardware display resources. An exemplary application of an electronic device with self-driving-based vehicle navigation provided in the embodiments of this application is described below. The device provided in the embodiments of this application may be implemented as various types of user terminals such as an in-vehicle terminal, a notebook computer, a tablet computer, a desktop computer, a set-top box, and a mobile device (for example, a mobile phone, a portable music player, a personal digital assistant, a dedicated message device, or a portable game device), or may be implemented as a server. An exemplary application of the device being implemented as an in-vehicle terminal is described below.

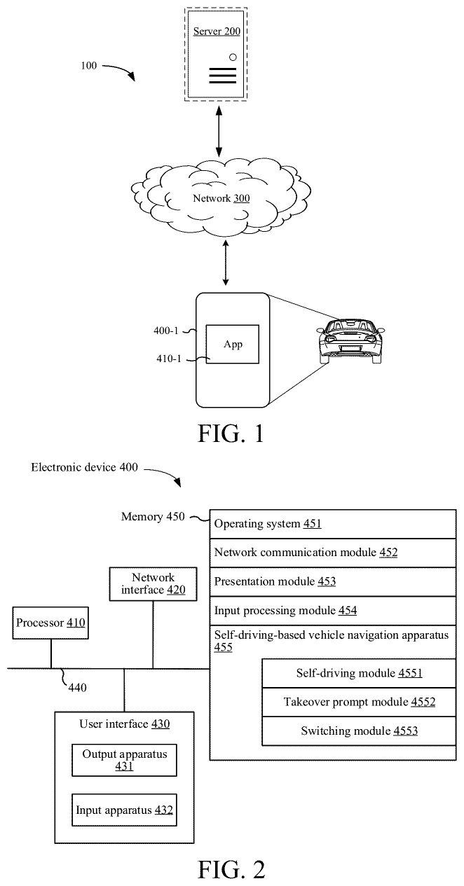

FIG. 1 is a schematic diagram of an architecture of a self-driving-based vehicle navigation system 100 according to an embodiment of this application. To support the implementation of one exemplary application, for example, when a driving object drives a vehicle, in response to a trigger operation on an in-vehicle terminal 400-1 equipped in the vehicle by the driving object, the vehicle is set to a self-driving state. In response to the vehicle in the self-driving state, the in-vehicle terminal 400-1 displays an assisted driving interface including self-driving information of the vehicle. When the vehicle is switched from the self-driving state to a manual driving state, the assisted driving interface is switched to a map navigation interface, and a navigation map is displayed in the map navigation interface. A terminal (the in-vehicle terminal 400-1 is exemplarily shown) is connected to a server 200 by a network 300. The network 300 may be a wide area network, a local area network, or a combination of the two, and a wireless or wired link is used to implement data transmission.

In some embodiments, the in-vehicle terminal 400-1 may be a mobile terminal that is carried by the driving object and establishes a communication connection with a control system of the vehicle, for example, a smartphone that establishes a communication connection with the control system of the vehicle, or may be a terminal installed in the vehicle. The in-vehicle terminal installed in the vehicle includes various external devices such as an in-vehicle video server, a touchscreen, and an external camera.

The terminal (for example, the in-vehicle terminal 400-1) is configured to: present a navigation interface of the self-driving vehicle in a graphical interface 410 (a graphical interface 410-1 is exemplarily shown), and transmit a state switching request to the server 200 in response to the vehicle being switched from the self-driving state to the manual driving state.

The server 200 is configured to receive the state switching request transmitted by the in-vehicle terminal and transmit navigation map data to the in-vehicle terminal 400-1.

The in-vehicle terminal 400-1 is further configured to display, based on the received navigation map data, a navigation map configured for navigating the vehicle.

In actual application, the server 200 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal (for example, the in-vehicle terminal 400-1) may be a smartphone, a tablet computer, a laptop computer, a desktop computer, a smart speaker, a smart television, a smart watch, or the like, but is not limited thereto. The terminal (for example, the in-vehicle terminal 400-1) and the server 200 may be directly or indirectly connected in a wired or wireless communication manner. This is not limited in this application.

In some embodiments, the self-driving-based vehicle navigation method provided in the embodiments of this application may be implemented by various electronic devices or computer devices, for example, may be separately implemented by an in-vehicle terminal, or may be separately implemented by a server, or may be implemented collaboratively by an in-vehicle terminal and a server. A structure of an electronic device that implements the self-driving-based vehicle navigation method provided in the embodiments of this application is described below. For example, the electronic device is an in-vehicle terminal. FIG. 2 is a schematic structural diagram of an electronic device 400 according to an embodiment of this application. The electronic device 400 shown in FIG. 2 includes at least one processor 410, a memory 450, at least one network interface 420, and a user interface 430. The components in the electronic device 400 are coupled together by a bus system 440. The bus system 440 is configured to implement connection and communication between the components. In addition to a data bus, the bus system 440 further includes a power bus, a control bus, and a status signal bus. However, for ease of clear description, all types of buses in FIG. 2 are marked as the bus system 440.

The processor 410 may be an integrated circuit chip having a signal processing capability, for example, a general purpose processor, a DSP, or another PLD, discrete gate, transistor logical device, or discrete hardware component. The general purpose processor may be a microprocessor, any conventional processor, or the like.

The user interface 430 includes one or more output apparatuses 431 that enable the presentation of media content, including one or more speakers and/or one or more visual display screens. The user interface 430 further includes one or more input apparatuses 432, including a user interface part that facilitates user input, for example, a keyboard, a mouse, a microphone, a touchscreen display, a camera, or another input button or entry.

The memory 450 may be a removable memory, a non-removable memory, or a combination thereof. An exemplary hardware device includes a solid-state memory, a hard disk drive, an optical disk drive, and the like. In some embodiments, the memory 450 includes one or more storage devices having physical locations far away from the processor 410.

The memory 450 includes a volatile memory or a non-volatile memory, or may include a volatile memory and a non-volatile memory. The non-volatile memory may be a read-only memory (ROM), and the volatile memory may be a random access memory (RAM). The memory 450 described in this embodiment of this application aims to include any suitable type of memories.

In some embodiments, the memory 450 can store data to support various operations. Examples of the data include a program, a module, a data structure, or a subset or superset thereof, and are exemplarily described below.

An operating system 451 includes system programs configured for processing various basic system services and performing hardware-related tasks, for example, a framework layer, a kernel library layer, and a driver layer, and is configured to implement various basic services and process hardware-based tasks.

A network communication module 452 is configured to reach another computing device through one or more (wired or wireless) network interfaces 420. An exemplary network interface 420 includes Bluetooth, Wireless Fidelity (Wi-Fi), a Universal Serial Bus (USB), and the like.

A presentation module 453 is configured to enable presentation of information (for example, a user interface configured for operating a peripheral and displaying content and information) through the one or more output apparatuses 431 (for example, a display screen, and a speaker) associated with the user interface 430.

An input processing module 454 is configured to detect a user input or interaction from the one or more input apparatuses 432 and translate the detected input or interaction.

In some embodiments, a self-driving-based vehicle navigation apparatus provided in the embodiments of this application may be implemented in a software manner. FIG. 2 shows a self-driving-based vehicle navigation apparatus 455 stored in the memory 450. The apparatus may be software in a form of a program, a plug-in, or the like, and includes the following software modules: a self-driving module 4551, a takeover prompt module 4552, and a switching module 4553. These modules are logical modules, and therefore may be combined or split in any manner according to functions to be implemented. The functions of the modules are described below.

In some other embodiments, the self-driving-based vehicle navigation apparatus provided in the embodiments of this application may be implemented in a hardware manner. In an example, the self-driving-based vehicle navigation apparatus provided in the embodiments of this application may be a processor in the form of a hardware decoding processor, and is programmed to perform the self-driving-based vehicle navigation method provided in the embodiments of this application. For example, the processor in the form of a hardware decoding processor may use one or more application-specific integrated circuits (ASIC), a DSP, a programmable logic device (PLD), a complex PLD (CPLD), a field programmable gate array (FPGA), or another electronic element.

Based on the foregoing description of the self-driving-based vehicle navigation system and the electronic device provided in the embodiments of this application, the self-driving-based vehicle navigation method provided in the embodiments of this application is described below. In some embodiments, the self-driving-based vehicle navigation method provided in the embodiments of this application may be separately implemented by a server or a terminal, or may be implemented collaboratively by a server and a terminal. The self-driving-based vehicle navigation method provided in the embodiments of this application is described below by using the implementation by an in-vehicle terminal equipped in a vehicle as an example.

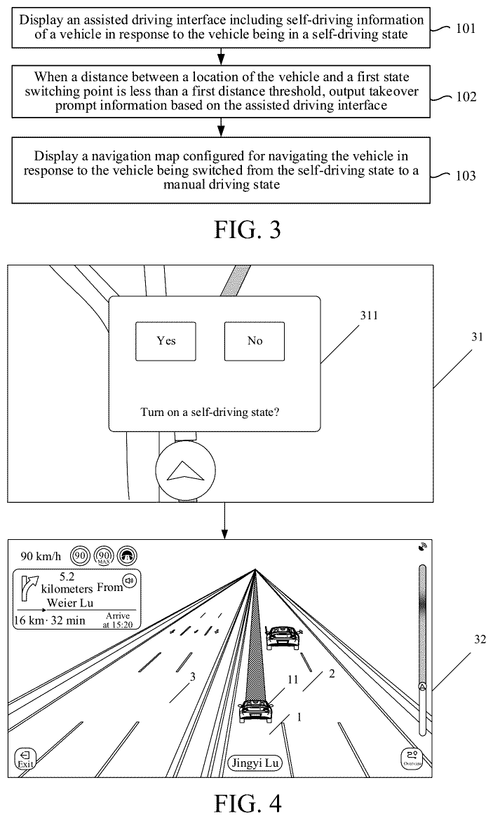

FIG. 3 is a schematic flowchart of a self-driving-based vehicle navigation method according to an embodiment of this application. Operation 101 to Operation 103 shown in FIG. 3 are used in conjunction for description.

Operation 101: An in-vehicle terminal displays an assisted driving interface including self-driving information of a vehicle in response to the vehicle being in a self-driving state.

In some embodiments, the vehicle is a vehicle that can travel in the self-driving state, i.e., a self-driving vehicle. The self-driving vehicle, also referred to as a driverless car, a computer-driven car, or a wheeled moving robot, is an intelligent car that implements driverless driving through a computer system. A self-driving car depends on the collaboration of artificial intelligence, visual computation, radar, and a global positioning system, to enable the computer system to automatically and safely operate a motor vehicle without any active operation by a human.

In some embodiments, the vehicle may have at least two self-driving levels. A self-driving level is configured for representing a capability of implementing autonomous driving by the vehicle, and a lower level corresponds to a lower capability. In some embodiments, according to a grading standard, the self-driving levels of the self-driving vehicle may include six levels L0 to L5. L0 represents conventional human driving without self-driving. To be specific, when a driving level of the vehicle is L0, it represents that the vehicle is in a manual driving state. When the driving level of the vehicle is one of L1 to L5, it represents that the vehicle is in the self-driving state. L1 to L5 are graded according to a maturity level of self-driving.
L0 level: A driver performs driving operations completely, and is fully manual driving. The vehicle only executes commands and does not perform driving intervention, including braking, steering, throttling, and power transmission. A danger needs to be determined by the driver.
L1 level: An automation system sometimes can assist a driver in completing some driving tasks, and can only assist the driver in completing one driving operation. The driver needs to detect a driving environment and perform takeover at any time.
L2 level: In a driving process, the system can control acceleration and deceleration, and can also control a steering wheel. A driver may abandon the main control right, but still needs to observe surroundings and provide a safety operation.
L3 level: When conditions permit, the vehicle can complete all driving operations. The level also has a function of reminding a driver. The driver does not need to detect a driving environment, is allowed to divert attention but not allowed to sleep, and needs to be able to take over the vehicle at any time, to handle a possible case beyond the capability of artificial intelligence. For example, lidar is indispensable, the support of a high-precision map is required, and a central processing unit configured to process a larger amount of more complex information and data is required.
L4 level: It is only needed to enter a place of departure and a destination before departure, and then a self-driving system can take full control of the vehicle. For example, laser, radar, a high-precision map, a central processing unit, and intelligent road and transportation facility are required.
L5 level: The definition of the L5 level of self-driving is similar to that of the L4 level, and an intelligent system independently completes all driving operations. However, a difference between the two lies in that the L4 level of self-driving is only applicable to some scenarios, usually standard roads with very simple road conditions, whereas the L5 level requires that a self-driving car complete full vehicle driving in all scenarios. In some embodiments, when the vehicle is in the self-driving state, the assisted driving interface including the self-driving information of the vehicle is displayed. The self-driving information may include at least one of the following information: information about a plurality of lanes of a road on which the vehicle is located, information about a current lane in which the vehicle is located, a traveling speed, a current traveling location, a traveling time, a traveling distance, a distance from a next point of interest, real-time vehicle condition information (for example, a remaining fuel level) of the vehicle, and the like. A route passing through the current lane may be a route that remains extending along the current lane, or may be a route that changes from the current lane to another lane on a traveling road ahead.

In actual application, when the driving level of the vehicle is one of L1 to L3, it may also be called that the vehicle is in a semi-self-driving state, and when the driving level of the vehicle is L4 or L5, it may also be called that the vehicle is in a full-self-driving state.

In some embodiments, the assisted driving interface is an interface displayed by a corresponding in-vehicle terminal when a vehicle is in a self-driving state (including a semi-self-driving state and a full-self-driving state). The interface is configured for displaying self-driving information of the vehicle in the self-driving state in real time, for example, a lane in which the vehicle is located, a speed of the vehicle, a self-driving duration of the vehicle in a current traveling process of the vehicle.

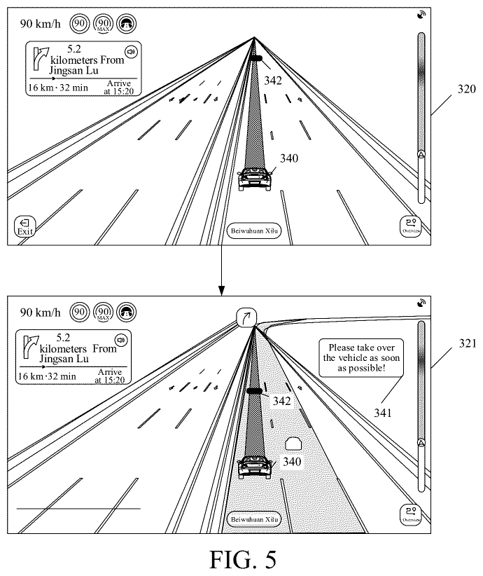

As an example, FIG. 4 is a schematic interface diagram of an assisted driving interface according to an embodiment of this application. In an assisted driving interface 32 shown in FIG. 4, the assisted driving interface 32 includes a road 1 on which the vehicle is located. For the road 1, apart from a first lane, a second lane (an advancing direction specified for the second lane may be the same as that specified for the first lane, or may be different from that specified for the first lane) different from the first lane and a traveling route passing through the first lane are further shown. In addition, the assisted driving interface 32 further includes a road 2 and a road 3.

The road on which the vehicle is located and a road on which the vehicle is not located are shown in the assisted driving interface. A route passing through a current road may be a route that remains extending along the current road, or may be a route that changes from the current road to another road on a traveling road ahead.

As an example, in the assisted driving interface 32 shown in FIG. 4, the assisted driving interface 32 includes the road 1 on which the vehicle is located. In addition, the assisted driving interface further includes the road 2 and the road 3.

For various self-driving information (for example, road information, lane information, and real-time location information) involved in a self-driving process of the vehicle, when the information is displayed, a corresponding prompt may be synchronously outputted in a manner of a text, speech, vibration, or the like, so that the safety of self-driving is improved from a plurality of dimensions, thereby implementing effective reminding.

When the vehicle is in the self-driving state, a real-time location of the vehicle in a lane is displayed in the assisted driving interface. As an example, in the assisted driving interface 32 shown in FIG. 4, the assisted driving interface 32 includes a traveling route passing through a first lane 1 and a real-time location (represented in a form of a vehicle 11 in FIG. 4) in the first lane 1.

In some embodiments, when the vehicle is in the manual driving state, a driving status of the vehicle may be switched to the self-driving state in the following manner: receiving, by the in-vehicle terminal, a switching instruction configured for indicating to switch from the manual driving state to the self-driving state, and controlling the vehicle to be switched from the manual driving state to the self-driving state in response to the switching instruction.

A triggering manner of the switching instruction is described. In some embodiments, the switching instruction may be triggered in the following manner: displaying, by the in-vehicle terminal, a self-driving control corresponding to a self-driving function, the self-driving control being configured for controlling the vehicle to be in the self-driving state, and receiving the switching instruction in response to a trigger operation on the self-driving control.

Various controls (for example, the self-driving control) mentioned in the embodiments of this application may be presented in various implementable manners such as a button, a key, a function item, and a function icon. This is not limited in the embodiments of this application.

In some embodiments, the switching instruction may be triggered in the following manner: outputting, by the in-vehicle terminal, switching prompt information, the switching prompt information being configured for prompting whether to switch from the self-driving state to the manual driving state; and triggering the switching instruction in response to a confirmation instruction on the switching prompt information. In actual application, the switching instruction may be triggered in another manner, for example, triggered by a speech instruction entered by a user. This is not limited in the embodiments of this application.

In actual application, a form of the switching prompt information may be a speech form, a text form, a graphic form, a picture and text form, or the like. For example, when the form of the switching prompt information is a speech form, an output of the in-vehicle terminal on the switching prompt information is playing the switching prompt information in a speech form.

A display occasion of the switching prompt information is described. In actual application, a server determines, based on a current traveling environment of the in-vehicle terminal, whether the vehicle can be switched to the self-driving state. For example, the server determines whether an acquisition precision of an environmental data acquisition apparatus is less than a minimum data precision required for the self-driving state in the current traveling environment. When the acquisition precision of the environmental data acquisition apparatus is not less than the minimum data precision required for the self-driving state in the current traveling environment, the in-vehicle terminal determines that the vehicle can be switched to the self-driving state. In actual application, in different traveling environments, minimum data precisions required for the self-driving state are different. In different environments, different minimum data precisions are set to ensure the traveling safety of the vehicle.

When determining that the vehicle can be switched to the self-driving state, the server transmits a signal indicating that self-driving can be turned on to the in-vehicle terminal to enable the in-vehicle terminal to output the switching prompt information. The signal indicating that self-driving can be turned on represents that the self-driving state can be turned on in a current driving environment of the vehicle. In this way, the in-vehicle terminal outputs switching prompt information to enable a user to learn a selectable driving state of the vehicle in time, thereby improving the utilization of display resources.

In some embodiments, the server may determine, in the following manner, whether the vehicle can be switched to the self-driving state: transmitting, by the in-vehicle terminal, real-time location information of the vehicle, and receiving calibrated location information returned by the server; determining a recognition precision of the vehicle on a traveling road based on the real-time location information and the calibrated location information; and transmitting the recognition precision to the server, to enable the server to compare the recognition precision with a data precision threshold to obtain a comparison result, the comparison result being configured for the server to determine whether to transmit the signal indicating that self-driving can be turned on. The comparison result represents whether a data precision is greater than the data precision threshold (a value of the data precision threshold may be set according to an actual case). The data precision threshold may be the minimum data precision required for the self-driving state. In some embodiments, after comparing the data precision with the data precision threshold to obtain the comparison result, the server may further perform the following processing: transmitting, by the server in response to the comparison result representing that the data precision is greater than the data precision threshold, the signal indicating that self-driving can be turned on. In response to the comparison result representing that the data precision is less than or equal to the data precision threshold, the server skips transmitting the signal indicating that self-driving can be turned on.

The calibrated location information can be configured for determining the recognition precision of the vehicle on the traveling road. In actual application, for a current location of the vehicle, based on a location acquired by the in-vehicle terminal and a calibrated location returned by the server, the recognition precision of the vehicle on the traveling road may be determined in the following manner: determining a real-time distance between the location acquired by the in-vehicle terminal and the calibrated location returned by the server, dividing a value of a preset target distance by a value of the real-time distance, and using a obtained value as the recognition precision of the vehicle on the traveling road. When the value of the preset target distance is equal to the value of the real-time distance, it may be obtained that the recognition precision is 1. As the value of the real-time distance increases, the recognition precision decreases.

In some embodiments, the foregoing determining a recognition precision of the vehicle on a traveling road based on the real-time location information and the calibrated location information may be implemented in the following manner: determining a difference between the real-time location information and the calibrated location information as an error of the vehicle on the traveling road; and determining a ratio of the error to the calibrated location information as the recognition precision of the vehicle on the traveling road.

In some embodiments, the switching prompt information may be outputted in at least one of a text manner (for example, displaying a text message configured for prompting whether to turn on a self-driving mode) or a speech manner (for example, playing a speech message configured for prompting whether to turn on a self-driving mode). In actual application, when the switching prompt information is outputted in the text manner, correspondingly, a selection control configured for selecting whether to turn on the self-driving state may be further displayed, to enable the user to trigger a confirmation instruction on the switching prompt information based on the selection control. When the switching prompt information is outputted in the speech manner, correspondingly, the in-vehicle terminal may acquire speech content of the user, and when acquiring a speech instruction for indicating to turn on a self-driving mode by the user, trigger the confirmation instruction on the switching prompt information.

As an example, referring to FIG. 4, the in-vehicle terminal receives the signal indicating that self-driving can be turned on, and displays a selection control 311 configured for selecting whether to turn on the self-driving state, to enable the user to trigger the confirmation instruction on the switching prompt information based on the selection control. In response to a trigger operation on a selection button “Yes” in the selection control 311, the in-vehicle terminal sets the vehicle to the self-driving state, and displays, in response to the vehicle being in the self-driving state, the assisted driving interface 32 including the self-driving information of the vehicle.

As an example, the in-vehicle terminal receives the signal indicating that self-driving can be turned on, and displays a text message configured for prompting that the self-driving state can be turned on. When the instruction for indicating to turn on the self-driving mode by the user is acquired (for example, a click operation on a physical button of the vehicle, or a response on an intelligent voice assistant (to turn on the self-driving state)), the confirmation instruction on the switching prompt information is triggered, the vehicle is set to the self-driving state, and the assisted driving interface including the self-driving information of the vehicle is displayed in response to the vehicle being in the self-driving state.

In this way, when the vehicle is in the self-driving state, the assisted driving interface including the self-driving information of the vehicle is displayed, so that the self-driving information of the vehicle can be intuitively presented through the assisted driving interface, making it convenient for the user to accurately learn related self-driving information, thereby effectively improving the traveling safety of the vehicle and the driving experience of the user.

Operation 102: When a distance between a location of the vehicle and a first state switching point is less than a first distance threshold, output takeover prompt information based on the assisted driving interface.

In some embodiments, the first state switching point is a location at which the vehicle is automatically switched from the self-driving state to a manual driving state on a road, and the takeover prompt information is configured for prompting a driving object of the vehicle to switch the vehicle from the self-driving state to the manual driving state by taking over the vehicle.

In a process of the vehicle traveling in the self-driving state, when a self-driving blind spot exists in front of the traveling vehicle, as the vehicle travels, the vehicle gradually approaches a state switching point, and the vehicle needs to be switched from the self-driving state to the manual driving state as soon as possible, to ensure the safety of the vehicle in a traveling process. In this case, the takeover prompt information may be outputted in the assisted driving interface to effectively prompt the driving object, to enable the driving object to take over the vehicle as soon as possible and switch the vehicle from the self-driving state to the manual driving state.

In some embodiments, the first state switching point may be a state switching point that does not support self-driving of the vehicle in a traveling route of the vehicle on a road. The vehicle can perform self-driving before the state switching point and cannot support self-driving after the state switching point. Therefore, the vehicle is automatically switched from the self-driving state to the manual driving state at this location. When the vehicle reaches the state switching point, the vehicle is automatically switched from the self-driving state to the manual driving state on the road. A case that does not support self-driving of the vehicle may be a case that a driving blind spot or the like exists and self-driving of the vehicle can no longer be supported, or a case that the traveling safety of self-driving can no longer be ensured. For example, on the road ahead, the vehicle needs to steer (a navigation precision of self-driving cannot meet a requirement, and the traveling safety of self-driving can no longer be ensured), travel into a ramp (a navigation precision of self-driving cannot meet a requirement, and the traveling safety of self-driving can no longer be ensured), or enter a tunnel (because a network cannot be connected, the vehicle cannot communicate with the server, and a traveling route cannot be accurately calculated depending on the computing capability of the vehicle).

In some embodiments, when the distance between the location of the vehicle and the first state switching point is less than the first distance threshold, after the takeover prompt information is outputted in the assisted driving interface and before the vehicle reaches the first state switching point, the vehicle may be switched from the self-driving state to the manual driving state in response to an operation (for example, an operation of holding the steering wheel, or an operation of stepping on a brake) on a related physical button of the vehicle by the driving object of the vehicle. In this way, when the distance between the location of the vehicle and the first state switching point is less than the first distance threshold, before the vehicle reaches the first state switching point, the driving object of the vehicle actively switches the vehicle from the self-driving state to the manual driving state through the reminder of the takeover prompt information, so that the vehicle has been switched from the self-driving state to the manual driving state before the vehicle reaches the first state switching point, thereby ensuring the traveling safety of the vehicle.

In some embodiments, if the driving object does not receive the reminder of the takeover prompt information or the driving object receives the takeover prompt information but takes no takeover measure when the distance between the location of the vehicle and the first state switching point is less than the first distance threshold and before the vehicle reaches the first state switching point, after the takeover prompt information is outputted in the assisted driving interface when the distance between the location of the vehicle and the first state switching point on the road is less than the first distance threshold, when the vehicle reaches the first state switching point, the vehicle is automatically switched from the self-driving state to the manual driving state on the road.

In some embodiments, the foregoing outputting takeover prompt information may be implemented in at least one of the following manners: displaying text information configured for prompting the driving object of the vehicle to take over the vehicle; playing speech information configured for prompting the driving object of the vehicle to take over the vehicle; and dynamically or statically displaying an icon configured for prompting the driving object of the vehicle to take over the vehicle.

In some embodiments, an output time of outputting the takeover prompt information may start when the distance between the location of the vehicle and the first state switching point is equal to a distance threshold and end when the driving object of the vehicle takes over the vehicle. Within the output time, the takeover prompt information may be outputted continuously, or the takeover prompt information may be outputted periodically. An output period may be determined according to an actual case. For example, the output period is positively correlated with the distance between the vehicle and the first state switching point, and the output period is negatively correlated with a frequency of outputting the takeover prompt information. To be specific, when the distance between the vehicle and the first state switching point is shorter, the frequency of outputting the takeover prompt information is higher. In this way, a prompt level of the takeover prompt information for the driving object can be effectively improved, to enable the driving object to take over the vehicle as soon as possible, and minimize a probability that the vehicle is taken over as late as the vehicle reaches the first state switching point, and advance the time of taking over the vehicle, so that the vehicle can be taken over as soon as possible as the vehicle is about to reach the first state switching point.

As an example, FIG. 5 is a schematic interface diagram of takeover prompt information according to an embodiment of this application. In response to a distance between a location 340 of the vehicle and a first state switching point 342 on a road being greater than or equal to the first distance threshold, takeover prompt information is not outputted in an assisted driving interface 320. When the distance between the location 340 of the vehicle and the first state switching point 342 is less than the first distance threshold, takeover prompt information 341 is outputted in an assisted driving interface 321.

In this way, the frequency of outputting the takeover prompt information is controlled according to the distance between the vehicle and the first state switching point. When the distance between the vehicle and the first state switching point is long, the takeover prompt information is outputted at a low frequency. When the distance between the vehicle and the first state switching point is short, the takeover prompt information is outputted at a high frequency. Because the distance between the vehicle and the first state switching point reflects an urgency level of taking over the vehicle, when the distance between the vehicle and the first state switching point is shorter, indicating that the urgency level of taking over the vehicle is higher, the takeover prompt information is outputted at a higher frequency, so that the vehicle is switched from the self-driving state to the manual driving state as soon as possible, to avoid self-driving on a road that is not suitable for self-driving, and provide better prompting for the driving object, thereby effectively improving the traveling safety of the vehicle.

After the vehicle is switched from the self-driving state to the manual driving state, the driving object needs to manually drive the vehicle to travel to a destination. A switching occasion of switching the vehicle from the self-driving state to the manual driving state is usually that a self-driving blind spot exists in front of the traveling vehicle, for example, a case that the vehicle needs to steer on the road ahead. Therefore, after the driving object takes over the vehicle, it may be needed to perform a steering operation as soon as possible to control the vehicle to steer to travel to the destination. To remind the driving object in advance to enable the driving object to accurately control the vehicle to travel according to a correct route after taking over the vehicle, a navigation route after the driving object takes over the vehicle may be displayed in advance when the distance between the location of the vehicle and the first state switching point is smaller than a first threshold, to enable the driving object to learn the navigation route after takeover of the vehicle before the driving object takes over the vehicle and get read in advance, so that the driving object performs a correct driving action as soon as the driving object takes over the vehicle or as soon as possible, thereby ensuring that the vehicle travels according to a correct traveling route.

In some embodiments, when the distance between the location of the vehicle and the first state switching point is less than the first distance threshold, the navigation route of the vehicle may be displayed in the following manner: displaying a navigation floating layer in the assisted driving interface, and displaying the navigation route of the vehicle in the navigation floating layer, or displaying a floating window, and displaying the navigation route of the vehicle in the floating window.

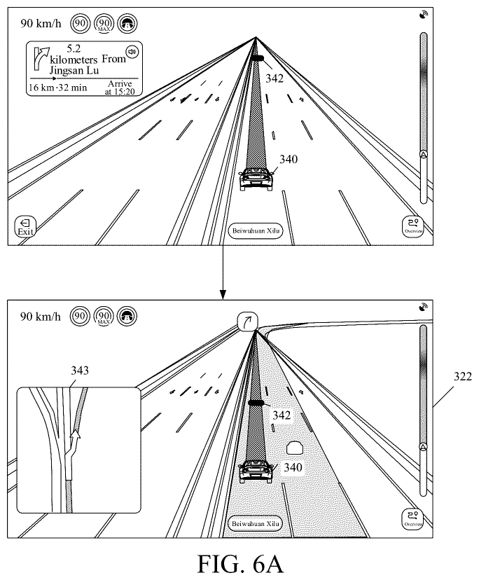

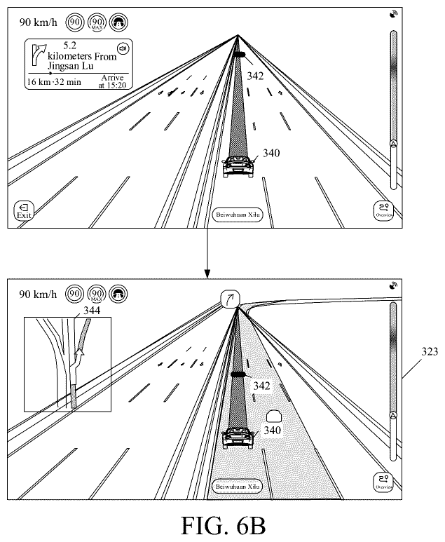

As an example, FIG. 6A is a schematic interface diagram of a navigation route in an assisted driving interface according to an embodiment of this application. When the distance between the location 340 of the vehicle and the first state switching point 342 is less than the first distance threshold, the navigation route of the vehicle is displayed through a floating window 343 in an assisted driving interface 322.

As an example, FIG. 6B is a schematic interface diagram of a navigation route in an assisted driving interface according to an embodiment of this application. When the distance between the location 340 of the vehicle and the first state switching point 342 is less than the first distance threshold, the navigation route of the vehicle is displayed through a navigation floating layer 344 in an assisted driving interface 323.

In this way, when the distance between the location of the vehicle and the first state switching point is less than the first distance threshold, the navigation route of the vehicle is displayed through the navigation floating layer or the floating window in the assisted driving interface. Before imminent takeover of the vehicle, through the display of the navigation route of the vehicle in the assisted driving interface, the driving object may be informed of the navigation route after the takeover of the vehicle in advance, so that before taking over the vehicle, the driving object learns a traveling route in time and performs path planning and driving action planning, thereby ensuring the driving safety after the vehicle is switched to the manual driving state.

To maximize the guidance performance of the displayed navigation route of the vehicle, in a traveling process of the vehicle, as the vehicle gradually approaches the first state switching point on the road, the strength of reminding the driving object may be increased by adjusting a display area of the navigation floating layer or the floating window configured for displaying the navigation route. For example, as the distance between the vehicle and the first state switching point decreases, the display area of the navigation floating layer or the floating window is gradually increased. To be specific, the distance between the vehicle and the first state switching point is controlled to have a negative correlation with the size of the display area. In actual application, the negative correlation may be a linear negative correlation. In this case, in one aspect, a display region of the navigation route displayed in the navigation floating layer or the floating window may be enlarged by increasing the display area, to enable the driving object to learn the navigation route after the takeover of the vehicle more clearly, and in another aspect, as the display area increases, the driving object may be reminded of the urgency level of taking over the vehicle.

In some embodiments, when the distance between the location of the vehicle and the first state switching point is less than the first distance threshold, the navigation route of the vehicle may be displayed in the following manner: when the navigation route of the vehicle is displayed in the navigation floating layer, in a process of the vehicle traveling based on the self-driving state, adjusting a display area of the navigation floating layer; or when the navigation route of the vehicle is displayed in the floating window, in a process of the vehicle traveling based on the self-driving state, adjusting a display area of the floating window, a size of the display area having a negative correlation with the distance.

In some embodiments, the display area of the navigation floating layer or the floating window is negatively correlated with the distance between the location of the vehicle and the first state switching point on the road. To be specific, when the distance is smaller, the display area of the navigation floating layer or the floating window is larger.

In some embodiments, because the navigation floating layer or the floating window is displayed in the assisted driving interface, the display area of the navigation floating layer or the display area of the floating window is discussed relative to the display area of the assisted driving interface. To be specific, a maximum value of the display area of the navigation floating layer or the floating window is smaller than or equal to the display area of the assisted driving interface.

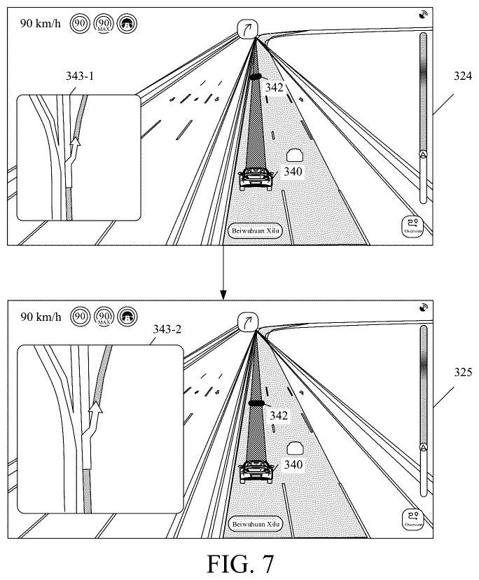

As an example, FIG. 7 is a schematic interface diagram of a navigation floating layer in an assisted driving interface according to an embodiment of this application. When the navigation route of the vehicle is displayed in the navigation floating layer, in the process of the vehicle traveling based on the self-driving state, the display area of the navigation floating layer is adjusted. At a first moment, in an assisted driving interface 324, the distance between the location 340 of the vehicle and the first state switching point 342 on the road is a first distance. In the process of the vehicle traveling based on the self-driving state, at a second moment, in an assisted driving interface 325, the distance between the location 340 of the vehicle and the first state switching point 342 on the road is a second distance. The first distance is greater than the second distance. A first display area of a navigation floating layer 343-1 in the assisted driving interface 324 is adjusted to a second display area of a navigation floating layer 343-2 in the assisted driving interface 325. The first display area is smaller than the second display area.

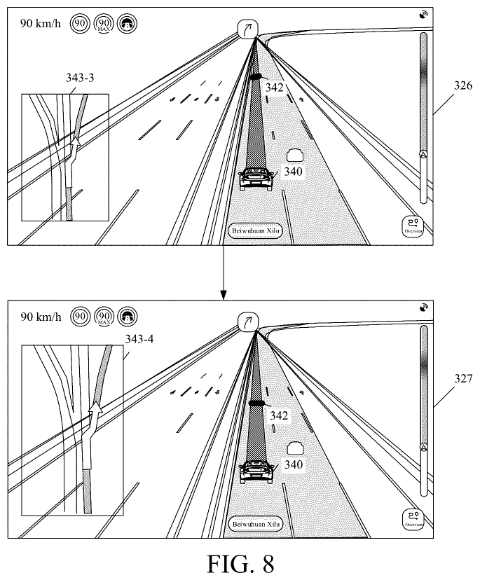

As an example, FIG. 8 is a schematic interface diagram of a floating window in an assisted driving interface according to an embodiment of this application. When the navigation route of the vehicle is displayed in the floating window, in the process of the vehicle traveling based on the self-driving state, the display area of the floating window is adjusted. At a first moment, in an assisted driving interface 326, the distance between the location 340 of the vehicle and the first state switching point 342 on the road is a first distance. In the process of the vehicle traveling based on the self-driving state, at a second moment, in an assisted driving interface 327, the distance between the location 340 of the vehicle and the first state switching point 342 on the road is a second distance. The first distance is greater than the second distance. A first display area of a floating window 343-3 in the assisted driving interface 326 is adjusted to a second display area of a floating window 343-4 in the assisted driving interface 327. The first display area is smaller than the second display area.

In this way, the display area of the navigation floating layer or the floating window is set to be negatively correlated with the distance between the location of the vehicle and the first state switching point on the road, so that in the process of the vehicle traveling based on the self-driving state, as the distance decreases, the urgency level of taking over the vehicle gradually increases. In a manner of gradually increasing the display area of the navigation floating layer or the floating window, while the driving object of the vehicle is reminded to take over the vehicle, the urgency level of taking over the vehicle is prompted to the driving object in a manner of gradually increasing the display area. In addition, the display area of the navigation floating layer or the floating window is gradually increased, the navigation route of the vehicle displayed in the navigation floating layer or the floating window is also gradually enlarged, and the driving object may be informed of the navigation route after the takeover of the vehicle in advance more clearly, so that before taking over the vehicle, the driving object learns a traveling route in time and performs path planning and driving action planning, thereby ensuring the driving safety after the vehicle is switched to the manual driving state.

To maximize the guidance performance of the displayed navigation route of the vehicle, in a traveling process of the vehicle, as the vehicle gradually approaches the first state switching point on the road, takeover guidance information may further be displayed in the assisted driving interface to guide the driving object to perform a correct target operation, to trigger the vehicle to be switched from the self-driving state to the manual driving state.

In some embodiments, when the distance between the location of the vehicle and the first state switching point is less than the first distance threshold, the takeover guidance information may be displayed in the following manner: displaying the takeover guidance information in the assisted driving interface, the takeover guidance information being configured for guiding the driving object to perform a target operation, the target operation being configured for triggering the vehicle to be switched from the self-driving state to the manual driving state.

In some embodiments, the target operation may be an operation of triggering the vehicle to be switched from the self-driving state to the manual driving state. For example, the target operation may be an operation performed by the driving object on any part or component in the vehicle, for example, a stepping operation on a brake in the vehicle, or may be a click operation on a physical button of the vehicle by the driving object, or may be a push operation on a manual stalk of the vehicle by the driving object.

In some embodiments, a guide manner of the takeover guidance information may be displaying an icon that imitates the driving object performing the target operation to guide the driving object to perform the target operation. The guide manner of the takeover guidance information may be displaying an animation that imitates the driving object performing the target operation to guide the driving object to perform the target operation. The guide manner of the takeover guidance information may be using a text reminder to guide the driving object to perform the target operation.

In some embodiments, when the guide manner of the takeover guidance information is displaying an animation that imitates the driving object performing the target operation, the displaying an animation that imitates the driving object performing the target operation may be implemented in the following manner: in response to a traveling direction being a straight direction, displaying an animation of hands holding the steering wheel when the vehicle moves straight in a guide window; and in response to the traveling direction being a steering direction, displaying an animation of hands holding the steering wheel when the vehicle steers in the guide window. In this way, according to the traveling direction of the vehicle, the driving object is guided through an animation to perform the target operation (a specific operation), to trigger the vehicle to be switched from the self-driving state to the manual driving state. Because the presentation of the target operation through an animation is more vivid and intuitive, the driving object can learn more easily an operation to be performed, so that the presentation forms of information are enriched, and the utilization of hardware display resources is improved.

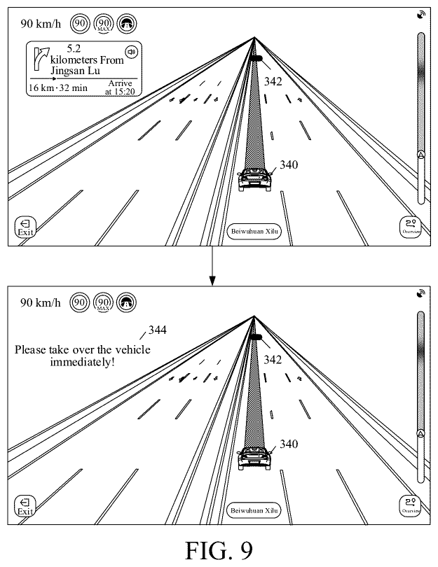

As an example, FIG. 9 is a schematic interface diagram of takeover guidance information in an assisted driving interface according to an embodiment of this application. In the assisted driving interface, takeover guidance information 344 (for example, text reminder information “Please take over the vehicle immediately”) is displayed in the assisted driving interface. The takeover guidance information 344 (for example, text reminder information “Please take over the vehicle immediately”) is configured for guiding the driving object to perform a target operation. The target operation is configured for triggering the vehicle to be switched from the self-driving state to the manual driving state.

In this way, when the distance between the location of the vehicle and the first state switching point on the road is less than the first distance threshold, the takeover guidance information is displayed in the assisted driving interface to guide the driving object to trigger the vehicle to be switched from the self-driving state to the manual driving state, so that the driving object can be informed of the navigation route after the takeover of the vehicle in advance more clearly, thereby ensuring the driving safety of the vehicle.

In some embodiments, a driving status icon may be displayed in the following manner: when the vehicle is in the self-driving state, displaying, in a first display style, the driving status icon configured for indicating the driving status of the vehicle. When the vehicle is switched from the self-driving state to the manual driving state, a display style of the driving status icon is switched from the first display style to a second display style. The second display style is configured for indicating that the driving status of the vehicle is the manual driving state.

In some embodiments, the driving status icon may be continuously displayed in a human-computer interaction interface. When the vehicle is in the self-driving state, the driving status icon is in a light-on style. When the vehicle is switched from the self-driving state to the manual driving state, the driving status icon is in a light-off style. To be specific, the first display style is the light-on style, and the second display style is the light-off style. To be specific, the driving status icon represents whether the vehicle is in the self-driving state, and in the light-on style, it represents that the vehicle is in the self-driving state.

In some other embodiments, the driving status icon may be continuously displayed in a human-computer interaction interface. When the vehicle is in the self-driving state, the driving status icon is in a light-off style. When the vehicle is switched from the self-driving state to the manual driving state, the driving status icon is in a light-on style. To be specific, the first display style is the light-off style, and the second display style is the light-on style. To be specific, the driving status icon represents whether the vehicle is in the manual driving state, and in the light-on style, it represents that the vehicle is in the manual driving state.

In some embodiments, the driving status icon may be displayed in the human-computer interaction interface in different styles according to the driving status of the vehicle. When the vehicle is in the self-driving state, the driving status icon is displayed in the human-computer interaction interface in the first display style, for example, an icon style of hands being off the steering wheel. When the vehicle is switched from the self-driving state to the manual driving state, the driving status icon is displayed in the human-computer interaction interface in the second display style, for example, an icon style of hands holding the steering wheel.

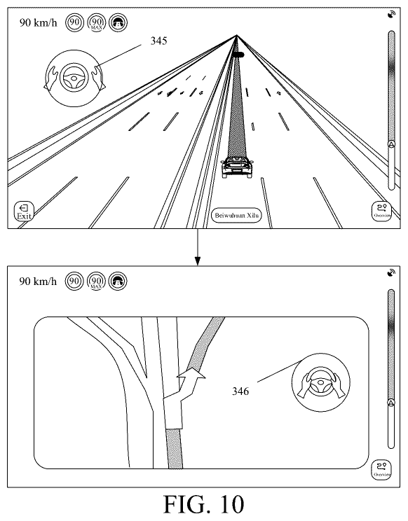

As an example, FIG. 10 is a schematic interface diagram of a driving status icon according to an embodiment of this application. When the vehicle is in the self-driving state, the driving status icon is displayed in the human-computer interaction interface in the first display style, for example, an icon style 345 of hands being off the steering wheel. When the vehicle is switched from the self-driving state to the manual driving state, the driving status icon is displayed in the human-computer interaction interface in the second display style, for example, an icon style 346 of hands holding the steering wheel.

In this way, the switching of the display style of the driving status icon is used to indicate the switching of the driving status, making it convenient for the driving object to intuitively observe the driving status of the vehicle, and driving behaviors are determined for different driving states, thereby ensuring the driving safety of the vehicle.

To maximize the guidance performance, in the traveling process of the vehicle, as the vehicle gradually approaches the first state switching point on the road, operation indication information may further be displayed in the assisted driving interface to guide the driving object to perform a correct control operation after taking over the vehicle, to enable the vehicle to travel according to a navigation route, thereby keeping the vehicle from traveling to a non-navigation route.

In some embodiments, when the distance between the location of the vehicle and the first state switching point is less than the first distance threshold, the operation indication information may be displayed in the following manner: displaying the operation indication information in the assisted driving interface, the operation indication information being configured for indicating a control operation that the driving object needs to perform on the vehicle after the vehicle is switched from the self-driving state to the manual driving state.

In some embodiments, the control operation includes at least one of the following: a power control operation, a direction control operation, and a speed control operation. The power control operation may be a stepping operation on a brake in the vehicle, or a stepping operation on an accelerator of the vehicle. The speed of the vehicle is controlled through the power control operation. The direction control operation may be a turning operation on the steering wheel of the vehicle by the driving object. The direction of the vehicle may be controlled through the direction control operation.

In some embodiments, an indication manner of the operation indication information may be displaying an icon that imitates the driving object performing the control operation to guide the driving object to perform the control operation. The indication manner of the operation indication information may be displaying an animation that imitates the driving object performing the control operation to guide the driving object to perform the target operation. The indication manner of the operation indication information may be displaying an operation indication text to guide the driving object to perform the control operation.

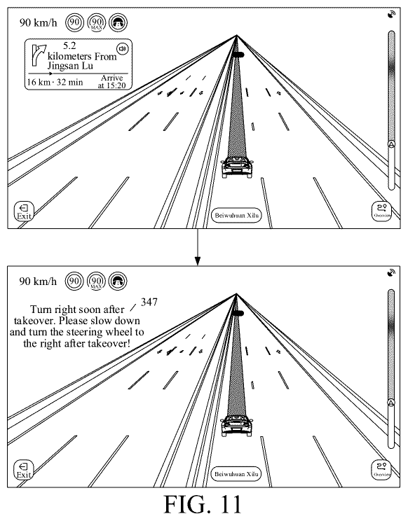

As an example, FIG. 11 is a schematic interface diagram of operation indication information according to an embodiment of this application. The operation indication information 347 is displayed in the assisted driving interface. The operation indication information 347 is configured for indicating a control operation that the driving object needs to perform on the vehicle after the vehicle is switched from the self-driving state to the manual driving state. The operation indication information 347 may be an operation indication text: Turn right soon after takeover. Please slow down and turn the steering wheel to the right after takeover.

In this way, the operation indication information is displayed in the assisted driving interface to indicate the control operation that the driving object needs to perform on the vehicle after the vehicle is switched from the self-driving state to the manual driving state, so that the driving object can perform a correct driving behavior after taking over the vehicle, thereby ensuring the driving safety of the vehicle.

To maximize the guidance performance, in the traveling process of the vehicle, as the vehicle gradually approaches the first state switching point on the road, state switching auxiliary information may further be displayed in the assisted driving interface to remind the driving object that the vehicle is gradually approaching the first state switching point and the driving object needs to take over the vehicle as soon as possible.

In some embodiments, when the distance between the location of the vehicle and the first state switching point is less than the first distance threshold, the operation indication information may be displayed in the following manner: displaying state switching auxiliary information in the assisted driving interface, the state switching auxiliary information including at least one of the following: the first state switching point, the distance, and a remaining time for the vehicle to travel to the first state switching point based on the self-driving state.

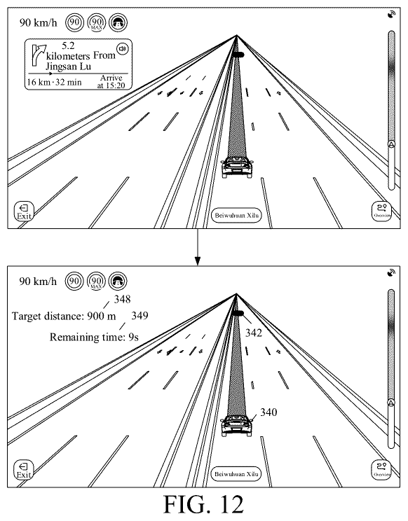

As an example, FIG. 12 is a schematic interface diagram of state switching auxiliary information according to an embodiment of this application. When the distance between the location of the vehicle and the first state switching point is less than the first distance threshold, the state switching auxiliary information is displayed in the assisted driving interface, the state switching auxiliary information including at least one of the following: a first state switching point 342, a distance 348 (the distance between the location 340 of the vehicle and the first state switching point 342, the distance: 900 m), and a remaining time 349 for the vehicle to travel to the first state switching point based on the self-driving state (the remaining time: 9s).

In this way, the state switching auxiliary information is displayed in the assisted driving interface, so that the driving object can learn the urgency level of taking over the vehicle through the state switching auxiliary information when the distance between the location of the vehicle and the first state switching point is less than the first distance threshold, and take over the vehicle in time, thereby ensuring the driving safety of the vehicle.

In some embodiments, when the state switching auxiliary information includes the distance, the displaying state switching auxiliary information in the assisted driving interface may be implemented in the following manner: displaying a traveling path of the vehicle in the assisted driving interface, and displaying a first path between the location of the vehicle and the first state switching point in a first style on the traveling path, the first style being configured for distinguishing the first path from a path other than the first path in the traveling path.

In some embodiments, the first path is a part of path in the traveling path of the vehicle, and is also referred to as a “first path segment” or a “target path segment” of the traveling path. The first path is a path between the first state switching point and the vehicle in the traveling path. The traveling path of the vehicle includes the first path and a path other than the first path, i.e., the traveling path includes the first path segment and another path segment other than the first path segment.

In some embodiments, the first style may be a target color style, a target line width style, or the like. When the first style is the target color style, the target color style may be red. In this case, a color style of the path other than the first path in the traveling path may be any color, for example, blue, other than red.

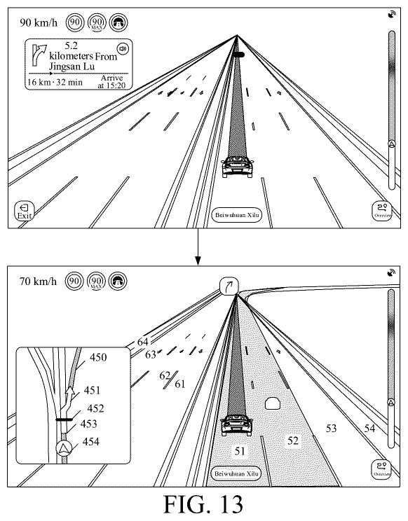

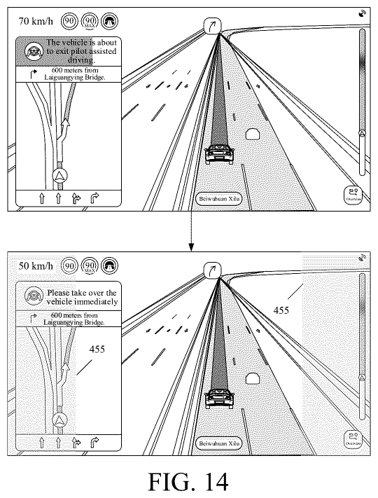

As an example, FIG. 13 is a schematic interface diagram of a traveling path according to an embodiment of this application. A traveling path 450 of the vehicle is displayed in the assisted driving interface, and a first path 453 between a location 454 of the vehicle and a first state switching point 452 is displayed in a first style on the traveling path 450, the first style being configured for distinguishing the first path 453 from a path 451 other than the first path in the traveling path 450.

In this way, the traveling path of the vehicle is displayed in the assisted driving interface, and the first path between the location of the vehicle and the first state switching point is displayed in the first style on the traveling path, to effectively distinguish the first path between the location of the vehicle and the first state switching point from the path other than the first path in the assisted driving interface. The first path is highlighted, so that the urgency level of taking over the vehicle can be accurately learned, and the vehicle can be taken over in time, thereby ensuring the driving safety of the vehicle.

In some embodiments, a travelable lane may further be displayed in the assisted driving interface in the following manner: displaying at least one travelable lane of the vehicle corresponding to a target location in a second style in the assisted driving interface, the at least one travelable lane including a lane in which the vehicle currently travels, the second style being configured for distinguishing the travelable lane from a lane other than the travelable lane in the assisted driving interface.

In some embodiments, the target location may be an end point of the navigation route of the vehicle, i.e., a destination of the navigation route. The road on which the vehicle travels has at least one traveling lane. Different roads may have different quantities of lanes, and are, for example, a two-lane two-way road, a four-lane two-way road, an eight-lane two-way road, a twelve-lane two-way road, a one-lane one-way road, a two-lane one-way road, and a four-lane one-way road. For example, a four-lane two-way road has two lanes traveling in a first direction and two lanes traveling in a second direction. The first direction and the second direction are opposite directions. In the two lanes traveling in the first direction, when two traveling directions, for example, a right turn direction and a straight direction, exist on the road ahead, in the two lanes traveling in the first direction, one is a right turn only lane, and the other is a straight only lane.

In some embodiments, the second style may be a target color style, a target line width style, or the like. When the second style is the target color style, the target color style may be red. In this case, a color style of a lane other than the travelable lane in the assisted driving interface may be any color other than red.

As an example, when the road on which the vehicle travels is a north-south eight-lane two-way road, because a direction in which the vehicle travels to the destination is fixed (i.e., the vehicle travels north or south to reach the destination), in this case, the vehicle has four lanes corresponding to the target location, to be specific, four lanes on which the vehicle can travel south or four lanes on which the vehicle can travel north. The lanes of the vehicle corresponding to the target location include a travelable lane of the vehicle corresponding to the target location and an untravelable lane of the vehicle corresponding to the target location.

As an example, when the lanes of the vehicle corresponding to the target location are four lanes traveling south, in the four lanes traveling south, two are straight lanes, and the other two are right turn lanes. The vehicle has two travelable lanes corresponding to the target location, and the vehicle has two untravelable lanes corresponding to the target location. To be specific, the travelable lanes of the vehicle corresponding to the target location are the right turn lanes in the four lanes traveling south, and the untravelable lanes of the vehicle corresponding to the target location are the straight lanes in the four lanes traveling south. Alternatively, the travelable lanes of the vehicle corresponding to the target location are the straight lanes in the four lanes traveling south, and the untravelable lanes of the vehicle corresponding to the target location are the right turn lanes in the four lanes traveling south.

As an example, the road shown in FIG. 13 is an eight-lane two-way road. The eight-lane two-way road includes four lanes (a lane 51, a lane 52, a lane 53, and a lane 54) traveling in the first direction and four lanes traveling in the second direction (a lane 61, a lane 62, a lane 63, and a lane 64). The four lanes traveling in the first direction include three conventional lanes (the lane 51, the lane 52, and the lane 53) and one emergency lane (the lane 54). The three conventional lanes (the lane 51, the lane 52, and the lane 53) are configured for traveling by all vehicles, and the emergency lane (the lane 54) is configured for traveling by a vehicle in an emergency. The four lanes traveling in the second direction has three conventional lanes and one emergency lane. At least one travelable lane (the lane 51 and the lane 52) of the vehicle corresponding to the target location is displayed in the second style in the assisted driving interface. The at least one travelable lane (the lane 51 and the lane 52) includes a lane (the lane 51) in which the vehicle currently travels. The second style is configured for distinguishing the travelable lane (the lane 51 and the lane 52) from a lane (the lane 53, the lane 54, the lane 61, the lane 62, the lane 63, and the lane 64) other than the travelable lane in the assisted driving interface.

In this way, at least one travelable lane of the vehicle corresponding to the target location is displayed in the second style in the assisted driving interface. With the second style, display effects of a travelable lane and another lane (a lane other than the travelable lane) are different, so that the travelable lane can be highlighted, and a clear travelable lane is prompted to the driving object, to enable the driving object to clearly distinguish the travelable lane from the lane other than the travelable lane in the assisted driving interface based on the display effect of the second style. The travelable lane is highlighted, so that the driving object can accurately determine a traveling route after taking over the vehicle, thereby ensuring the driving safety of the vehicle.

In the traveling process of the vehicle, as the location of the vehicle gradually approaches the first state switching point on the road, to remind the driving object of the urgency level of taking over the vehicle and enable the vehicle to be switched from the self-driving state to the manual driving state before the first state switching point as much as possible, as the vehicle approaches the first state switching point, a strong reminder can be provided to the driving object in a manner of outputting takeover alarm information, to enable the driving object to learn the urgency of taking over the vehicle.

In some embodiments, after the takeover prompt information is outputted, the takeover alarm information may be outputted in the following manner: in response to the distance between the location of the vehicle and the first state switching point on the road being less than a second distance threshold and the second distance threshold being less than the first distance threshold, outputting, in a strong reminder manner, takeover alarm information configured for reminding takeover of the vehicle, a takeover urgency level of the vehicle corresponding to the takeover alarm information being higher than a takeover urgency level of the vehicle corresponding to the takeover prompt information.

In some embodiments, the second distance threshold is less than the first distance threshold. When the distance between the location of the vehicle and the first state switching point on the road is less than the second distance threshold, the distance between the location of the vehicle and the first state switching point on the road is already very small, and the urgency level of taking over the vehicle is already very high. In this case, the takeover alarm information configured for reminding the takeover of the vehicle may be outputted in a strong reminder manner.

In some embodiments, the outputting takeover alarm information configured for reminding takeover of the vehicle may be implemented in the following manner: displaying the takeover alarm information configured for reminding the takeover of the vehicle. The displayed takeover alarm information may be at least one of takeover alarm information in a text form or takeover alarm information in a graphic form. For an output manner of such takeover alarm information, a corresponding strong reminder manner may be at least one of flashing display, highlighted display, a gradually increasing font or graphic.

The outputting takeover alarm information configured for reminding takeover of the vehicle may be alternatively implemented in the following manner: playing a takeover alarm information speech configured for reminding takeover of the vehicle, i.e., playing takeover alarm information configured for reminding takeover of the vehicle as speech. For an output manner of such takeover alarm information, a corresponding strong reminder manner may be repetitive speech announcement or gradually increasing volume in a process of playing speech repetitively.

In some embodiments, an output time of the outputting takeover alarm information configured for reminding takeover of the vehicle may start when the distance is equal to the second distance threshold and end when the driving object takes over the vehicle. Within the output time, an output period may be determined according to an actual case. For example, the output period is positively correlated with the distance, and the output period is negatively correlated with the frequency of outputting the takeover alarm information. To be specific, when the distance between the vehicle and the first state switching point is shorter, the frequency of outputting the takeover alarm information is higher.

In some embodiments, in an implementation of outputting takeover alarm information configured for reminding takeover of the vehicle, when the takeover alarm information configured for reminding takeover of the vehicle is displayed, the strong reminder manner may be flashing display or highlighted display. In an implementation of outputting takeover alarm information configured for reminding takeover of the vehicle, when the takeover alarm information configured for reminding takeover of the vehicle is displayed, the strong reminder manner may be repetitive speech announcement, and gradually increasing volume in a process of playing speech repetitively.

As an example, FIG. 14 is a schematic interface diagram of takeover alarm information according to an embodiment of this application. In response to the distance between the location of the vehicle and the first state switching point on the road being less than the second distance threshold, outputting, in a strong reminder manner, takeover alarm information 455 configured for reminding takeover of the vehicle (the takeover alarm information is displayed in a manner of flashing and highlighting a caution light at an edge of the assisted driving interface, and when the distance between the vehicle and the first state switching point is shorter, the flashing frequency of the takeover alarm information is higher).

As an example, in response to the distance between the location of the vehicle and the first state switching point on the road being less than the second distance threshold, the manner of repetitive speech announcement and gradually increasing volume in a process of playing speech repetitively is used to play a takeover alarm information speech “Please take over immediately”.

In this case, in response to the distance between the location of the vehicle and the first state switching point on the road being less than the second distance threshold, the takeover alarm information configured for reminding takeover of the vehicle is outputted in a strong reminder manner, so that the driving object can sense that the takeover urgency level of the vehicle corresponding to the takeover alarm information is higher than the takeover urgency level of the vehicle corresponding to the takeover prompt information and take over the vehicle as soon as possible, and the driving object can accurately learn the urgency level of taking over the vehicle, thereby ensuring the driving safety of the vehicle.

In the traveling process of the vehicle, as the vehicle gradually approaches the first state switching point, the urgency level of taking over the vehicle gradually increases. To feed back the urgency level of taking over the vehicle to the driving object and enable the driving object to take over the vehicle as soon as possible, the driving object can sense the urgency level of taking over the vehicle by controlling a value of volume, a font size, or the like and take over the vehicle as soon as possible, to enable the vehicle to be switched from the self-driving state to the manual driving state.

In some embodiments, when the output manner of the takeover prompt information is a speech output manner, in the process of outputting the takeover prompt information, the volume corresponding to the takeover prompt information is dynamically adjusted, the value of the volume having a negative correlation with the distance.

In some embodiments, when the output manner of the takeover prompt information is a speech output manner, in the traveling process of the vehicle, the distance between the location of the vehicle and the first state switching point on the road gradually decreases, and the urgency level of taking over the corresponding vehicle gradually increases. Therefore, in this case, the driving object can be reminded to take over the vehicle as soon as possible in a manner of gradually turning up the volume corresponding to the takeover prompt information, so that the driving object can learn, through the volume of the takeover prompt information, the urgency level of taking over the vehicle, and take over the vehicle as soon as possible, thereby ensuring the driving safety of the vehicle.

As an example, the value of volume has a negative correlation with the distance. When the distance is shorter, the volume is higher, and when the distance is longer, the volume is lower.

In some embodiments, when the output manner of the takeover prompt information is a text output manner, in the process of outputting the takeover prompt information, the font size of the text corresponding to the takeover prompt information is dynamically adjusted, the font size having a negative correlation with the distance.

In some embodiments, when the output manner of the takeover prompt information is a text output manner, in the traveling process of the vehicle, the distance between the location of the vehicle and the first state switching point on the road gradually decreases, and the urgency level of taking over the corresponding vehicle gradually increases. Therefore, in this case, the driving object can be reminded to take over the vehicle as soon as possible in a manner of gradually increasing the font size of the text corresponding to the takeover prompt information, so that the driving object can learn, through the font size of the text corresponding to the takeover prompt information, the urgency level of taking over the vehicle, and take over the vehicle as soon as possible, thereby ensuring the driving safety of the vehicle.

As an example, the font size of the text corresponding to the takeover prompt information has a negative correlation with the distance. When the distance is shorter, the font size is larger, and when the distance is longer, the font size is smaller.

Operation 103: Display a navigation map configured for navigating the vehicle in response to the vehicle being switched from the self-driving state to a manual driving state.

When the vehicle is in the self-driving state, the driving object of the vehicle may perform a related operation on the vehicle to switch the vehicle from the self-driving state to the manual driving state. When the vehicle is switched from the self-driving state to the manual driving state, the in-vehicle terminal of the vehicle may display the navigation map configured for navigating the vehicle.

In some embodiments, the switching occasion of switching the vehicle from the self-driving state to the manual driving state may be determined by the driving object of the vehicle. For example, the vehicle is switched from the self-driving state to the manual driving state in response to an operation (for example, an operation of holding the steering wheel, or an operation of stepping on a brake) on a related physical button of the vehicle by the driving object of the vehicle.

In some embodiments, the switching occasion of switching the vehicle from the self-driving state to the manual driving state may be determined by an actual condition of a road, for example, a case in which a self-driving blind spot exists in front of the traveling vehicle (for example, on the road ahead, the vehicle needs to steer, travel into a ramp, or enter a tunnel (a network cannot be connected)) and self-driving of the vehicle can no longer be supported, and in response to the vehicle reaching a corresponding state switching point, the vehicle is automatically switched from the self-driving state to the manual driving state.

In a process of the vehicle traveling in the self-driving state, when a self-driving blind spot exists in front of the traveling vehicle, as the vehicle travels, the vehicle gradually approaches a state switching point, and the vehicle needs to be switched from the self-driving state to the manual driving state as soon as possible. In this case, the takeover prompt information may be outputted in the assisted driving interface to effectively prompt the driving object, to enable the driving object to take over the vehicle as soon as possible and switch the vehicle from the self-driving state to the manual driving state.

In some embodiments, when the navigation map configured for navigating the vehicle is displayed, the following processing may be performed: outputting a switching complete prompt message, the switching complete prompt information being configured for prompting that the vehicle has been switched to the manual driving state. In this way, through a current takeover prompt of the driving status of the vehicle, the driving object can clearly learn that the vehicle is currently in the manual driving state already, so that the driving object can focus on the driving of the vehicle, thereby improving the driving safety.

In some embodiments, the outputting switching complete prompt information may be implemented by performing at least one of the following manners: displaying a text message configured for prompting that the vehicle has been switched to the manual driving state; and playing a speech message configured for prompting that the vehicle has been switched to the manual driving state.

In the traveling process of the vehicle, as the vehicle gradually approaches the first state switching point, the urgency level of taking over the vehicle gradually increases. To feed back the urgency level of taking over the vehicle to the driving object and enable the driving object to take over the vehicle as soon as possible, a traveling progress bar of the vehicle may be displayed in the assisted driving interface, and a location corresponding to the first state switching point is identified in the progress bar, so that the driving object can clearly sense a location relationship between the location of the vehicle and the first state switching point, to determine the urgency level of taking over the vehicle, thereby taking over the vehicle as soon as possible.

In some embodiments, the following processing may be performed: displaying a traveling progress bar of the vehicle in the assisted driving interface; and identifying the location corresponding to the first state switching point in the traveling progress bar.

In some embodiments, the traveling progress bar may be configured for indicating a degree of completion of the vehicle traveling to a navigation destination, or the traveling progress bar may be configured for indicating a degree of completion of the vehicle traveling to the first state switching point.

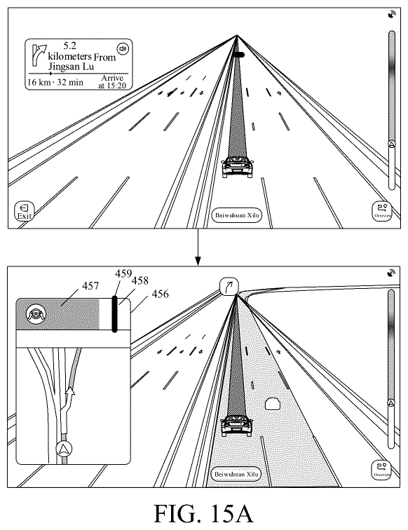

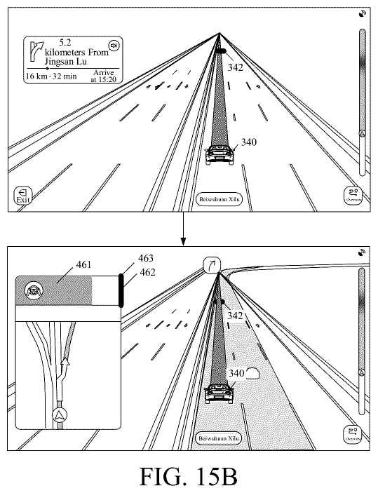

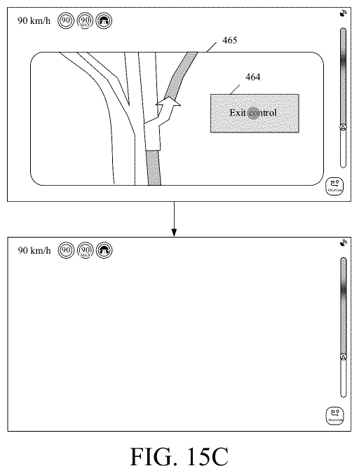

As an example, FIG. 15A is a schematic interface diagram of a traveling progress bar according to an embodiment of this application. A traveling progress bar 456 of the vehicle is displayed in the assisted driving interface, the traveling progress bar 456 is configured for indicating a degree of completion of the vehicle traveling to the navigation destination, and the traveling progress bar 456 includes a completed part 457 and an uncompleted part 458. The completed part 457 is configured for indicating a proportion of a traveled path in an entire navigation path in the process of the vehicle traveling to the navigation destination. The uncompleted part 458 is configured for indicating a proportion of an untraveled path in the entire navigation path in the process of the vehicle traveling to the navigation destination. A location 459 corresponding to the first state switching point is identified in the traveling progress bar 456.

As an example, FIG. 15B is a schematic interface diagram of a traveling progress bar according to an embodiment of this application. A traveling progress bar 460 of the vehicle is displayed in the assisted driving interface, the traveling progress bar 460 is configured for indicating a degree of completion of the vehicle 340 traveling to the first state switching point 342, and the traveling progress bar 460 includes a completed part 461 and an uncompleted part 462. The completed part 461 is configured for indicating a proportion of a length of a traveled path in a length of the first distance threshold in the process of the vehicle traveling to the first state switching point 342. The uncompleted part 462 is configured for indicating a proportion of a length of an untraveled path in the length of the first distance threshold in the process of the vehicle traveling to the first state switching point. A location 463 corresponding to the first state switching point is identified in the traveling progress bar 462.

In some embodiments, when the traveling progress bar is configured for indicating the degree of completion of the vehicle traveling to the navigation destination, an occasion of displaying the traveling progress bar may be the time when the vehicle starts navigation and displays the assisted driving interface. When the traveling progress bar is configured for indicating the degree of completion of the vehicle traveling to the first state switching point, the occasion of displaying the traveling progress bar may be the time when the distance between the location of the vehicle and the first state switching point on the road is less than the first distance threshold.

In this way, the traveling progress bar is displayed in the assisted driving interface and the location corresponding to the first state switching point is identified in the traveling progress bar, so that while intuitively learning a driving progress of the vehicle through the traveling progress bar, the driving object may determine a distance between a current location of the vehicle and the first state switching point through a relative location relationship between the progress in the traveling progress bar and the first state switching point, determine, through the distance, the urgency level of taking over the vehicle, and take over the vehicle as soon as possible, thereby ensuring the driving safety of the vehicle. In some embodiments, the navigation map configured for navigating the vehicle is configured for guiding the driving object to drive the vehicle according to the navigation route in a manual driving mode.

To enable the driving object to autonomously cancel display of the navigation map when the driving object does not need the navigation map for assisted driving, after the navigation map including the navigation route of the vehicle is displayed in a map navigation interface, a corresponding exit control may be further displayed for ease of canceling the display of the navigation map.

In some embodiments, after Operation 103, the following processing may be performed: displaying an exit control corresponding to the navigation map; and canceling display of the navigation map in response to a trigger operation on the exit control.

In some embodiments, the exit control is configured for guiding the driving object to confirm whether to cancel the display of the navigation map. The trigger operation on the exit control may be a single-tap operation, a double-tap operation, or the like on the exit control, and a triggering manner of the trigger operation does not constitute a limitation to this application.

In some embodiments, in the map navigation interface, after the navigation map including the navigation route of the vehicle is displayed, the driving object may be relatively familiar with a route reaching a destination and does not need to be guided to the destination through the navigation map. In this case, an exit control corresponding to the navigation map is displayed, so that in a case that the driving object is relatively familiar with a route in the navigation map, the driving object exists the navigation map through a trigger operation on the exit control, so that the running consumption of a computing device is effectively reduced, thereby improving the running efficiency of the computing device.

As an example, FIG. 15C is a schematic interface diagram of a traveling progress bar according to an embodiment of this application. In the map navigation interface, after the navigation map including the navigation route of the vehicle is displayed, an exit control 464 corresponding to the navigation map is displayed. Display of a navigation map 465 is canceled in response to a trigger operation on the exit control 464.

In this way, in the map navigation interface, after the navigation map including the navigation route of the vehicle is displayed, the exit control may be displayed, making it convenient for the driving object to autonomously choose to cancel the display of the navigation map in a case that the driving object can drive the vehicle without using the navigation map.

To make the displayed navigation map better adapt to navigation requirements of the driving object, a map mode of the navigation map may further be switched.

In some embodiments, a map mode switching control may further be displayed in the map navigation interface. After Operation 103, the map mode may be switched in the following manner: switching a map mode of the navigation map from a first map mode to a second map mode in response to a trigger operation on the map mode switching control.

In some embodiments, the first map mode is different from the second map mode. When the first map mode is a two-dimensional map mode, the second map mode may be a three-dimensional map mode. When the first map mode is a three-dimensional map mode, the second map mode may be a two-dimensional map mode. When the first map mode is an augmented reality navigation mode, the second map mode may be a lane-level navigation mode. When the first map mode is a lane-level navigation mode, the second map mode may be an augmented reality navigation mode.

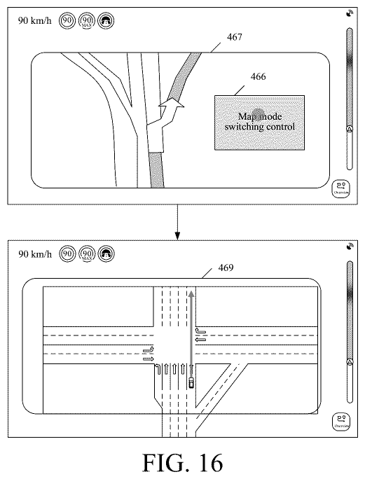

As an example, FIG. 16 is a schematic interface diagram of a map mode switching control according to an embodiment of this application. The map mode of the navigation map is switched from a first map mode 467 to a second map mode 469 in response to a trigger operation (for example, a single-tap operation) on a map mode switching control 466.

In this way, the map mode switching control is displayed in the map navigation interface, and the map mode is switched in response to the trigger operation on the map mode switching control, to meet requirements of map modes by different driving objects and in different driving environments.

After the vehicle is switched to the manual driving mode, as the vehicle travels, when the vehicle meets a condition of the self-driving mode, the vehicle may further be switched from the manual driving mode to the self-driving mode, so that under different driving conditions, a driving mode that meets a driving requirement of the driving object is provided.

In some embodiments, after Operation 103, state switching prompt information may be displayed in the following manner: in response to a switching condition for switching from the manual driving state to the self-driving state being met, displaying the state switching prompt information in the map navigation interface. The state switching prompt information is configured for prompting that it is allowed to switch a driving status of the vehicle from the manual driving state to the self-driving state.

In some embodiments, a display manner of the state switching prompt information may be displayed in a manner of a state switching prompt information text, or may be displayed in a manner of a self-driving control.

In some embodiments, after the state switching prompt information is displayed, the vehicle is switched from the manual driving state to the self-driving state in response to the trigger operation on the state switching prompt information.

In some embodiments, after the state switching prompt information is displayed, the vehicle is switched from the manual driving state to the self-driving state in response to the trigger operation on state switching.

In some embodiments, the switching condition for switching the vehicle from the manual driving state to the self-driving state may be a condition that a self-driving blind spot does not exist in front of the traveling vehicle (for example, the vehicle has left a steering lane, has left a ramp, or has left a tunnel (a network cannot be connected)) and self-driving of the vehicle can still be supported.

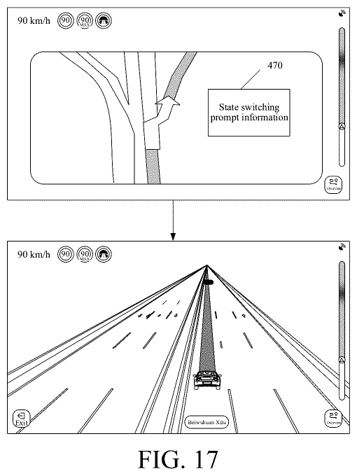

As an example, FIG. 17 is a schematic interface diagram of state switching prompt information according to an embodiment of this application. In response to the switching condition for switching from the manual driving state to the self-driving state being met, state switching prompt information 470 is displayed in the map navigation interface, and the vehicle is switched from the manual driving state to the self-driving state in response to the trigger operation on state switching.

In this way, when the switching condition for switching from the manual driving state to the self-driving state is met, the state switching prompt information is displayed in the map navigation interface, so that when the driving object needs to switch the vehicle to the self-driving state, the vehicle can be switched to the self-driving state in time, thereby reducing the driving burden of the driving object, and the function of the self-driving state can be effectively utilized, thereby reducing the driving burden of the driving object.

In some embodiments, after Operation 103, a second state switching point may be displayed in the following manner: displaying the second state switching point in the map navigation interface, the second state switching point being a location at which a switching condition for switching from the manual driving state to the self-driving state is met on the road on which the vehicle travels.

In some embodiments, before the vehicle travels to the second state switching point, the vehicle does not meet a switching condition for switching to the self-driving state. After the vehicle travels to the second state switching point, the vehicle meets a condition for switching to the self-driving state.

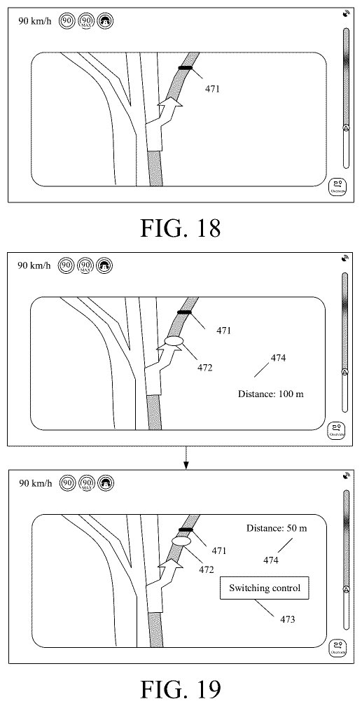

As an example, FIG. 18 is a schematic interface diagram of a second state switching point according to an embodiment of this application. A second state switching point 471 is displayed in the map navigation interface, the second state switching point 471 being a location at which a switching condition for switching from the manual driving state to the self-driving state is met on the road on which the vehicle travels.

In this way, the second state switching point is displayed in the map navigation interface, so that the driving object may accurately learn a switching occasion of switching from the self-driving state to the manual driving state. In a process of the driving object driving the vehicle manually, in a case that the switching condition is met, the driving object switches the vehicle to the self-driving state as soon as possible, so that the function of the self-driving state can be effectively utilized, thereby reducing the driving burden of the driving object.

In some embodiments, after Operation 103, the distance between the location of the vehicle and the second state switching point may be displayed in the following manner: displaying the distance between the location of the vehicle and the second state switching point in the map navigation interface, and when the distance is less than a distance threshold, displaying a switching control configured for switching from the manual driving state to the self-driving state.

In some embodiments, when the distance between the location of the vehicle and the second state switching point is less than the distance threshold, the vehicle is about to meet the switching condition for switching from the manual driving state to the self-driving state. In this case, the switching control configured for switching from the manual driving state to the self-driving state is displayed, to enable the driving object to perform an operation on the switching control. After the vehicle meets the switching condition for switching from the manual driving state to the self-driving state, the vehicle may be switched from the manual driving state to the self-driving state in response to the trigger operation on the switching control.

As an example, FIG. 19 is a schematic interface diagram of a distance between a location of a vehicle and a second state switching point according to an embodiment of this application. A distance 474 between a location 472 of the vehicle and a second state switching point 471 is displayed in the map navigation interface, and when the distance 474 is less than a distance threshold, a switching control 473 configured for switching from the manual driving state to the self-driving state is displayed.

In this way, in a process of a vehicle being in a self-driving state, when a distance between the vehicle and a state switching point of a driving status is less than a distance threshold, a driving object is prompted to take over the vehicle, and when the vehicle has been switched from the self-driving state to a manual driving state, a navigation map configured for navigating the vehicle is displayed. With the prompt of takeover prompt information, the driving object can take over the vehicle as soon as possible, to avoid a vehicle accident due to a failure to take over the vehicle in time after the vehicle is automatically switched from the self-driving state to the manual driving state. In addition, because the navigation map can be displayed in time when the vehicle is switched to the manual driving state, the driving object can accurately perform corresponding driving operations according to the navigation map, to implement the in-depth integration of self-driving and map navigation, so that while the sense of driving safety of a user is improved, the guidance performance in self-driving is improved.

An exemplary application of the embodiments of this application in an actual application scenario of self-driving navigation of a vehicle is described below.

In some actual application scenarios of self-driving navigation of the vehicle, a self-driving navigation map is displayed in response to the vehicle in a self-driving state; it is acquired in real time, according to the navigation route, whether a road section in front of a user supports assisted self-driving (i.e., whether a self-driving blind spot exists), and when the user is about to travel to a toll station, a ramp, or another road section that does not support assisted self-driving (i.e., a self-driving blind spot), starting from a set distance (for example, 1 kilometer) from the self-driving blind spot, a manual-driving navigation map is displayed in the self-driving navigation map, and Text To Speech (TTS) announcement is used in combination; starting from a key node, caution takeover prompt information is transmitted to the user, including, but not limited to, a guide animation effect of hands taking hold of the steering wheel from a slow speed to a fast speed, and a map panel flashing warning from a slow speed to a fast speed, and information such as TTS speech announcement or beeps from a slow speed to a fast speed is used in combination, thereby effectively performing takeover guide for a driving user.

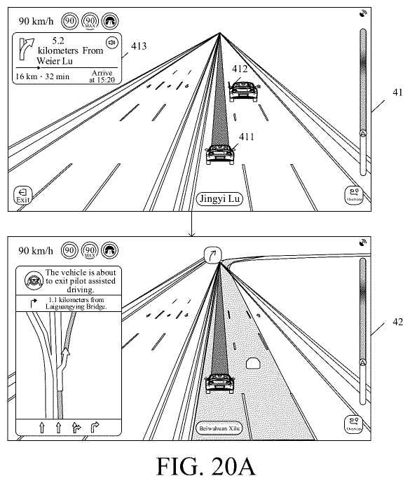

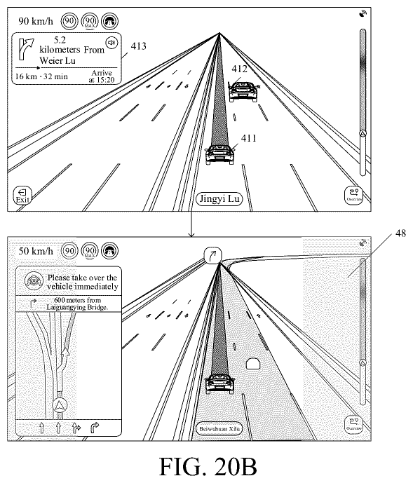

FIG. 20A is a schematic effect diagram of a self-driving-based vehicle navigation method according to an embodiment of this application. In response to a vehicle in a self-driving state, a self-driving navigation interface 41 shown in FIG. 20A is displayed in a navigation interface. In the self-driving navigation interface, a traveling trajectory and a traveling path of a vehicle 411 are displayed, and a nearby vehicle 412 in front of the vehicle 411, a vehicle speed of the vehicle 411, a traffic regulation (for example, a speed limit of 90 Km/h) of a current road, and a guidance panel 413 of the vehicle 411 are displayed. Key traveling information, for example, a remaining distance (16 kilometers), a remaining traveling duration (16 kilometers), traveling path prompt information (5.2 kilometers from Weier Lu), and an expected time (15:20) of arrival, of the vehicle 411 on a navigation path are displayed in the guidance panel 413.

Referring to FIG. 20A, when a road ahead no longer supports self-driving and a driving object needs to take over the vehicle, a navigation map panel appears on the left side. The panel carries two parts of information: (1) specific information of the vehicle in the self-driving state, for example, “The vehicle is about to exit pilot assisted driving,” and “Please take over the vehicle immediately”; and (2) information about a next action after a person takes over the vehicle, for example, “1.1 kilometers from Laiguangying Bridge”. In addition, an accurate action location and lane line information of a current travelable lane are displayed through the map. Through the in-depth integration of the two parts of information, two important prompts are conveyed to a user. To be specific, one prompt is that it is necessary to take over the vehicle, and the other prompt is that an action (turn right to enter Laiguangying Bridge) needs to be performed after takeover. In addition, an exit boundary line appears in front in a guide path on the right side to indicate that self-driving is to be exited at a location in front if takeover is not performed. As the vehicle gradually approaches the boundary line, the guide path becomes shorter and shorter and eventually disappears, and the vehicle exists self-driving and enters a manual driving state.

FIG. 20B is a schematic effect diagram of a self-driving-based vehicle navigation method according to an embodiment of this application. When a distance between the vehicle and the boundary line is less than a distance threshold, the vehicle is about to exit self-driving, and a flashing decorative border animation 48 is displayed at an edge of a display interface to prompt the driving object to take over the vehicle immediately.

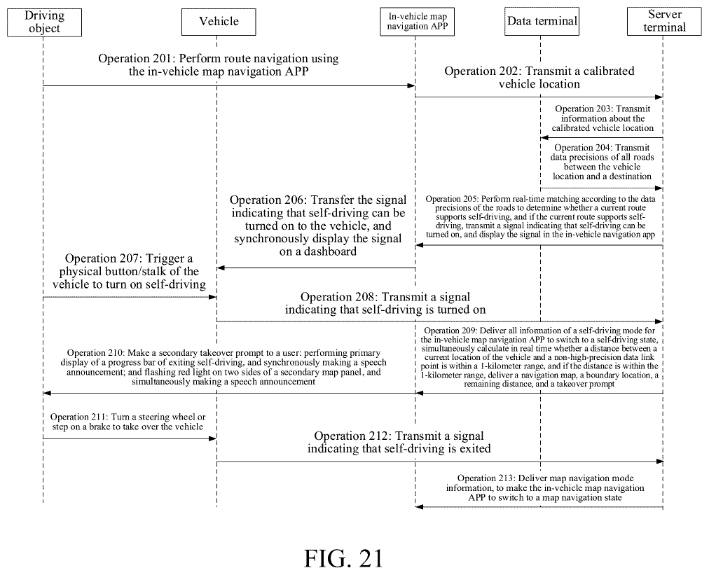

In some embodiments, FIG. 21 is a schematic flowchart of a self-driving-based vehicle navigation method according to an embodiment of this application. Operation 201 to Operation 213 shown in FIG. 21 are used in conjunction for description.

Operation 201: A driving object performs route navigation using an in-vehicle map navigation application (APP).

Operation 202: The in-vehicle map navigation APP transmits a calibrated vehicle location.

Operation 203: A server terminal transmits information about the calibrated vehicle location.

Operation 204: A data terminal transmits data precisions of all roads between the vehicle location and a destination.

Operation 205: Perform real-time matching according to the data precisions of the roads to determine whether a current route supports self-driving, and when the current route supports self-driving, transmit a signal indicating that self-driving can be turned on, and display the signal in the in-vehicle map navigation APP.

Operation 206: The in-vehicle map navigation APP transfers the signal indicating that self-driving can be turned on to a vehicle, and synchronously displays the signal on a dashboard of the vehicle.

Operation 207: The driving object triggers a physical button/stalk of the vehicle to turn on self-driving.

Operation 208: The vehicle transmits a signal indicating that self-driving is turned on to the server terminal.

Operation 209: The server terminal delivers all information of a self-driving mode to the in-vehicle map navigation APP for the in-vehicle map navigation APP to switch to a self-driving state, simultaneously calculates in real time whether a distance between a current location of the vehicle and a non-high-precision data link point is within a 1-kilometer range, and if the distance is within the 1-kilometer range, the server terminal delivers a navigation map, a boundary location, a remaining distance, and a takeover prompt to the in-vehicle map navigation APP.

Operation 210: The in-vehicle map navigation APP makes a secondary takeover prompt to the driving object: performing primary display of a progress bar of exiting self-driving, and synchronously making a speech announcement; and flashing light on two sides of a secondary picture, and synchronously making a speech announcement.

Operation 211: The driving object turns a steering wheel or steps on a brake to take over the vehicle.

Operation 212: The vehicle transmits a signal indicating that self-driving is exited to the server terminal.

Operation 213: The server terminal delivers map navigation mode information to the in-vehicle map navigation APP, to make the in-vehicle map navigation APP to switch to a map navigation state.

In this way, in a case that self-driving is about to be exited, a map navigation panel is displayed, so that the driving object clearly knows a next action (where to go after taking over the vehicle) after taking over the vehicle, so that the driving safety of the driving object can be effectively improved, and is kept from incorrect traveling due to switching of driving modes (switching from the self-driving mode to the manual driving mode). The appearance of the map navigation panel can also provide a transition link with exiting self-driving to enter a map navigation mode, so that the driving object is provided in advance with a process of adapting to switching of map modes, thereby ensuring the reading efficiency of navigation information by the driving object. In a case that self-driving is about to be exited, a boundary location for exiting self-driving is displayed in front of a guide path, so that the anxiety of the driving object can be effectively reduced, and the driving object is kept from performing an incorrect operation as soon as a takeover prompt appears.

In the embodiments of this application, related data such as self-driving information is involved. When the embodiments of this application are used in products or technologies, user permissions or agreements need to be obtained, and the collection, use and processing of relevant data need to comply with the relevant laws, regulations, and standards of the relevant countries and regions.

An exemplary structure of a self-driving-based vehicle navigation apparatus 455 provided in the embodiments of this application being implemented as software modules continues to be described below. In some embodiments, as shown in FIG. 2, the software modules in the self-driving-based vehicle navigation apparatus 455 stored in the memory 450 may include:
a self-driving module 4551, configured to display an assisted driving interface including self-driving information of a vehicle in response to the vehicle being in a self-driving state; a takeover prompt module 4552, configured to: when a distance between a location of the vehicle and a first state switching point is less than a first distance threshold, output takeover prompt information based on the assisted driving interface, the first state switching point being a location at which the vehicle is automatically switched from the self-driving state to a manual driving state on a road, the takeover prompt information being configured for prompting a driving object of the vehicle to switch the vehicle from the self-driving state to the manual driving state by taking over the vehicle; and a switching module 4553, configured to display a navigation map configured for navigating the vehicle in response to the vehicle being switched from the self-driving state to the manual driving state.

In some embodiments, the self-driving-based vehicle navigation apparatus 455 provided in the embodiments of this application further includes: a display module, configured to display a navigation route of the vehicle through a navigation floating layer or a floating window in the assisted driving interface.

In some embodiments, the self-driving-based vehicle navigation apparatus 455 provided in the embodiments of this application further includes: an adjustment module, configured to: when the navigation route of the vehicle is displayed in the navigation floating layer, in a process of the vehicle traveling based on the self-driving state, adjust a display area of the navigation floating layer; or when the navigation route of the vehicle is displayed in the floating window, in a process of the vehicle traveling based on the self-driving state, adjust a display area of the floating window, a size of the display area of the floating window having a negative correlation with the distance.

In some embodiments, the self-driving-based vehicle navigation apparatus 455 provided in the embodiments of this application further includes: displaying takeover guidance information in the assisted driving interface, the takeover guidance information being configured for guiding the driving object to perform a target operation, the target operation being configured for triggering the vehicle to be switched from the self-driving state to the manual driving state.

In some embodiments, the self-driving-based vehicle navigation apparatus 455 provided in the embodiments of this application further includes: an indication information module, configured to display operation indication information in the assisted driving interface, the operation indication information being configured for indicating a control operation that the driving object needs to perform on the vehicle after the vehicle is switched from the self-driving state to the manual driving state.

In some embodiments, the self-driving-based vehicle navigation apparatus 455 provided in the embodiments of this application further includes: a switching auxiliary information module, configured to display state switching auxiliary information in the assisted driving interface, the state switching auxiliary information including at least one of the following: the first state switching point, the distance, and a remaining time for the vehicle to travel to the first state switching point based on the self-driving state.

In some embodiments, the switching auxiliary information module is further configured to display a traveling path of the vehicle in the assisted driving interface, and displaying a first path between the location of the vehicle and the first state switching point in a first style on the traveling path, the first style being configured for distinguishing the first path from a path other than the first path in the traveling path.

In some embodiments, the self-driving-based vehicle navigation apparatus 455 provided in the embodiments of this application further includes: a lane display module, configured to display at least one travelable lane of the vehicle corresponding to a target location in a second style in the assisted driving interface, the at least one travelable lane including a lane in which the vehicle currently travels, the second style being configured for distinguishing the travelable lane from a lane other than the travelable lane in the assisted driving interface.

In some embodiments, the self-driving-based vehicle navigation apparatus 455 provided in the embodiments of this application further includes: a takeover alarm module, configured to: in response to the distance between the location of the vehicle and the first state switching point on the road being less than a second distance threshold and the second distance threshold being less than the first distance threshold, output, in a strong reminder manner, takeover alarm information configured for reminding takeover of the vehicle, a takeover urgency level of the vehicle corresponding to the takeover alarm information being higher than a takeover urgency level of the vehicle corresponding to the takeover prompt information.

In some embodiments, the self-driving-based vehicle navigation apparatus 455 provided in the embodiments of this application further includes: a volume adjustment module, configured to: when an output manner of the takeover prompt information is a speech output manner, in a process of outputting the takeover prompt information, dynamically adjust volume of the takeover prompt information, a value of the volume having a negative correlation with the distance; and a font adjustment module, configured to: when the output manner of the takeover prompt information is a text output manner, in the process of outputting the takeover prompt information, dynamically adjust a font size of a text corresponding to the takeover prompt information, the font size having a negative correlation with the distance.

In some embodiments, the self-driving-based vehicle navigation apparatus 455 provided in the embodiments of this application further includes: a progress module, configured to: display a traveling progress bar of the vehicle in the assisted driving interface; and identify the location corresponding to the first state switching point in the traveling progress bar.

In some embodiments, the self-driving-based vehicle navigation apparatus 455 provided in the embodiments of this application further includes: a display cancellation module, configured to: display an exit control corresponding to the navigation map; and cancel display of the navigation map in response to a trigger operation on the exit control.

In some embodiments, the self-driving-based vehicle navigation apparatus 455 provided in the embodiments of this application further includes: a switching control display module, configured to display a map mode switching control in the map navigation interface; and a mode switching module, configured to switch a map mode of the navigation map from a first map mode to a second map mode in response to a trigger operation on the map mode switching control.

In some embodiments, the self-driving-based vehicle navigation apparatus 455 provided in the embodiments of this application further includes: a state switching prompt information module, configured to: in response to a switching condition for switching from the manual driving state to the self-driving state being met, display state switching prompt information in the map navigation interface, the state switching prompt information being configured for prompting that it is allowed to switch a driving status of the vehicle from the manual driving state to the self-driving state.

In some embodiments, the self-driving-based vehicle navigation apparatus 455 provided in the embodiments of this application further includes: a second state switching point module, configured to display a second state switching point in the map navigation interface, the second state switching point being a location at which a switching condition for switching from the manual driving state to the self-driving state is met on the road on which the vehicle travels.

In some embodiments, the self-driving-based vehicle navigation apparatus 455 provided in the embodiments of this application further includes: a distance display module, configured to: display a distance between the location of the vehicle and the second state switching point in the map navigation interface, and when the distance is less than a distance threshold, display a switching control configured for switching from the manual driving state to the self-driving state.

Embodiments of this application provide a computer program product, the computer program product including a computer program or computer executable instructions, the computer program or computer executable instructions being stored in a computer-readable storage medium. A processor of a computer device reads the computer executable instructions from the computer-readable storage medium, and the processor executes the computer executable instructions, to cause the electronic device to perform the foregoing self-driving-based vehicle navigation method provided in the embodiments of this application.

Embodiments of this application provide a computer-readable storage medium having computer executable instructions stored therein, having computer executable instructions stored therein, the computer executable instructions, when being executed by a processor, causing the processor to perform the self-driving-based vehicle navigation method provided in the embodiments of this application, for example, the self-driving-based vehicle navigation method shown in FIG. 3.

In some embodiments, the computer-readable storage medium may be a read-only memory (ROM), a random access memory (RAM), an erasable programmable read-only memory (EPROM), an electrically erasable programmable read-only memory (EEPROM), a flash memory, a magnetic surface memory, an optical disc, a CD-ROM, or another memory, or may be or may be various devices including one or any combination of the foregoing memories.

In some embodiments, the executable instructions may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

In an example, the executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

As an example, the executable instructions may be deployed to be executed on one computing device, or executed on a plurality of computing devices located at one place, or executed on a plurality of computing devices that are distributed at a plurality of places and are interconnected by a communication network.

In summary, the embodiments of this application have the following beneficial effects:
(1) In a process of a vehicle being in a self-driving state, when a distance between the vehicle and a state switching point of a driving status is less than a distance threshold, a driving object is prompted to take over the vehicle, and when the vehicle has switched from the self-driving state to a manual driving state, a navigation map configured for navigating the vehicle is displayed. With the prompt of takeover prompt information, the driving object can take over the vehicle as soon as possible, to avoid a vehicle accident due to a failure to take over the vehicle in time after the vehicle is automatically switched from the self-driving state to the manual driving state. In addition, because the navigation map can be displayed in time when the vehicle is switched to the manual driving state, the driving object can accurately perform a corresponding driving operation according to the navigation map, to implement the in-depth integration of self-driving and map navigation, so that while the sense of driving safety of a user is improved, the guidance performance in self-driving is improved.
(2) The frequency of outputting the takeover prompt information is controlled according to the distance between the vehicle and the first state switching point. When the distance between the vehicle and the first state switching point is long, the takeover prompt information is outputted at a low frequency. When the distance between the vehicle and the first state switching point is short, the takeover prompt information is outputted at a high frequency. Because the distance between the vehicle and the first state switching point reflects an urgency level of taking over the vehicle, when the distance between the vehicle and the first state switching point is shorter, indicating that the urgency level of taking over the vehicle is higher, the takeover prompt information is outputted at a higher frequency, so that the vehicle is switched from the self-driving state to the manual driving state as soon as possible, to avoid self-driving on a road that is not suitable for self-driving, and provide better prompting for the driving object, thereby effectively improving the traveling safety of the vehicle.
(3) When the distance between the location of the vehicle and the first state switching point is less than the first distance threshold, the navigation route of the vehicle is displayed through the navigation floating layer or the floating window in the assisted driving interface. Before imminent takeover of the vehicle, through the display of the navigation route of the vehicle in the assisted driving interface, the driving object may be informed of the navigation route after the takeover of the vehicle in advance, so that before taking over the vehicle, the driving object learns a traveling route in time and performs path planning and driving action planning, thereby ensuring the driving safety after the vehicle is switched to the manual driving state.
(4) The display area of the navigation floating layer or the floating window is set to be negatively correlated with the distance between the location of the vehicle and the first state switching point on the road, so that in the process of the vehicle traveling based on the self-driving state, as the distance decreases, the urgency level of taking over the vehicle gradually increases. In a manner of gradually increasing the display area of the navigation floating layer or the floating window, while the driving object of the vehicle is reminded to take over the vehicle, the urgency level of taking over the vehicle is prompted to the driving object in a manner of gradually increasing the display area. In addition, the display area of the navigation floating layer or the floating window is gradually increased, the navigation route of the vehicle displayed in the navigation floating layer or the floating window is also gradually enlarged, and the driving object may be informed of the navigation route after the takeover of the vehicle in advance more clearly, so that before taking over the vehicle, the driving object learns a traveling route in time and performs path planning and driving action planning, thereby ensuring the driving safety after the vehicle is switched to the manual driving state.
(5) When the distance between the location of the vehicle and the first state switching point on the road is less than the first distance threshold, the takeover guidance information is displayed in the assisted driving interface to guide the driving object to trigger the vehicle to be switched from the self-driving state to the manual driving state, so that the driving object can be informed of the navigation route after the takeover of the vehicle in advance more clearly, thereby ensuring the driving safety of the vehicle.
(6) The switching of the display style of the driving status icon is used to indicate the switching of the driving status, making it convenient for the driving object to intuitively observe the driving status of the vehicle, and driving behaviors are determined for different driving states, thereby ensuring the driving safety of the vehicle.
(7) The operation indication information is displayed in the assisted driving interface to indicate the control operation that the driving object needs to perform on the vehicle after the vehicle is switched from the self-driving state to the manual driving state, so that the driving object can perform a correct driving behavior after taking over the vehicle, thereby ensuring the driving safety of the vehicle.
(8) The state switching auxiliary information is displayed in the assisted driving interface, so that the driving object can learn the urgency level of taking over the vehicle through the state switching auxiliary information when the distance between the location of the vehicle and the first state switching point is less than the first distance threshold, and take over the vehicle in time, thereby ensuring the driving safety of the vehicle.
(9) The traveling path of the vehicle is displayed in the assisted driving interface, and the first path between the location of the vehicle and the first state switching point is displayed in the first style on the traveling path, to effectively distinguish the first path between the location of the vehicle and the first state switching point from the path other than the first path in the assisted driving interface. The first path is highlighted, so that the urgency level of taking over the vehicle can be accurately learned, and the vehicle can be taken over in time, thereby ensuring the driving safety of the vehicle.
(10) In response to the distance between the location of the vehicle and the first state switching point on the road being less than the second distance threshold, the takeover alarm information configured for reminding takeover of the vehicle is outputted in a strong reminder manner, so that the driving object can sense that the takeover urgency level of the vehicle corresponding to the takeover alarm information is higher than the takeover urgency level of the vehicle corresponding to the takeover prompt information and take over the vehicle as soon as possible, and the driving object can accurately learn the urgency level of taking over the vehicle, thereby ensuring the driving safety of the vehicle.
(11) When the output manner of the takeover prompt information is a speech output manner, in the traveling process of the vehicle, the distance between the location of the vehicle and the first state switching point on the road gradually decreases, and the urgency level of taking over the corresponding vehicle gradually increases. Therefore, in this case, the driving object can be reminded to take over the vehicle as soon as possible in a manner of gradually turning up the volume corresponding to the takeover prompt information, so that the driving object can learn, through the volume of the takeover prompt information, the urgency level of taking over the vehicle, and take over the vehicle as soon as possible, thereby ensuring the driving safety of the vehicle.
(12) When the output manner of the takeover prompt information is a text output manner, in the traveling process of the vehicle, the distance between the location of the vehicle and the first state switching point on the road gradually decreases, and the urgency level of taking over the corresponding vehicle gradually increases. Therefore, in this case, the driving object can be reminded to take over the vehicle as soon as possible in a manner of gradually increasing the font size of the text corresponding to the takeover prompt information, so that the driving object can learn, through the font size of the text corresponding to the takeover prompt information, the urgency level of taking over the vehicle, and take over the vehicle as soon as possible, thereby ensuring the driving safety of the vehicle.
(13) The traveling progress bar is displayed in the assisted driving interface and the location corresponding to the first state switching point is identified in the traveling progress bar, so that while intuitively learning a driving progress of the vehicle through the traveling progress bar, the driving object may determine a distance between a current location of the vehicle and the first state switching point through a relative location relationship between the progress in the traveling progress bar and the first state switching point, determine, through the distance, the urgency level of taking over the vehicle, and take over the vehicle as soon as possible, thereby ensuring the driving safety of the vehicle.
(14) In the map navigation interface, after the navigation map including the navigation route of the vehicle is displayed, the driving object may be relatively familiar with a route reaching a destination and does not need to be guided to the destination through the navigation map. In this case, an exit control corresponding to the navigation map is displayed, so that in a case that the driving object is relatively familiar with a route in the navigation map, the driving object exists the navigation map through a trigger operation on the exit control, so that the running consumption of a computing device is effectively reduced, thereby improving the running efficiency of the computing device.
(15) In the map navigation interface, after the navigation map including the navigation route of the vehicle is displayed, the exit control may be displayed, making it convenient for the driving object to autonomously choose to cancel the display of the navigation map in a case that the driving object can drive the vehicle without using the navigation map.
(16) The map mode switching control is displayed in the map navigation interface, and the map mode is switched in response to the trigger operation on the map mode switching control, to meet requirements of map modes by different driving objects and in different driving environments.
(17) When the switching condition for switching from the manual driving state to the self-driving state is met, the state switching prompt information is displayed in the map navigation interface, so that when the driving object needs to switch the vehicle to the self-driving state, the vehicle can be switched to the self-driving state in time, thereby reducing the driving burden of the driving object, and the function of the self-driving state can be effectively utilized, thereby reducing the driving burden of the driving object.
(18) The second state switching point is displayed in the map navigation interface, so that the driving object may accurately learn a switching occasion of switching from the self-driving state to the manual driving state. In a process of the driving object driving the vehicle manually, in a case that the switching condition is met, the switching object switches the vehicle to the self-driving state as soon as possible, so that the function of the self-driving state can be effectively utilized, thereby reducing the driving burden of the driving object.
(19) In a case that self-driving is about to be exited, a map navigation panel is displayed, so that the driving object clearly knows a next action (where to go after taking over the vehicle) after taking over the vehicle, so that the driving safety of the driving object can be effectively improved, and is kept from incorrect traveling due to switching of driving modes (switching from the self-driving mode to the manual driving mode). The appearance of the map navigation panel can also provide a transition link with exiting self-driving to enter a map navigation mode, so that the driving object is provided in advance with a process of adapting to switching of map modes, thereby ensuring the reading efficiency of navigation information by the driving object. In a case that self-driving is about to be exited, a boundary location for exiting self-driving is displayed in front of a guide path, so that the anxiety of the driving object can be effectively reduced, and the driving object is kept from performing an incorrect operation as soon as a takeover prompt appears.
(20) At least one travelable lane of the vehicle corresponding to the target location is displayed in the second style in the assisted driving interface, to effectively distinguish between a travelable lane and a lane other than the travelable lane in the assisted driving interface. The travelable lane is highlighted, so that a traveling route after takeover of the vehicle can be accurately acquired, thereby ensuring the driving safety of the vehicle.

The foregoing descriptions are merely embodiments of this application and are not intended to limit the scope of protection of this application. Any modification, equivalent replacement, or improvement made without departing from the spirit and range of this application shall fall within the scope of protection of this application.

What is claimed is:

1. A vehicle navigation method, performed by an electronic device, comprising:
displaying an assisted driving interface including self-driving information of a vehicle in response to the vehicle being in a self-driving state;
in response to a distance between a location of the vehicle and a state switching point being shorter than a distance threshold, outputting takeover prompt information based on the assisted driving interface, the state switching point being a location on a road at which the vehicle is automatically switched from the self-driving state to a manual driving state; and
displaying a navigation map in response to the vehicle being switched from the self-driving state to the manual driving state.

2. The method according to claim 1, further comprising:
displaying a navigation floating layer or a floating window; and
displaying a navigation route of the vehicle in the navigation floating layer or the floating window.

3. The method according to claim 2, further comprising:
while the vehicle is traveling based on the self-driving state, adjusting a display area of the navigation floating layer or the floating window, a size of the display area of the navigation floating layer or the floating window being negatively correlated with the distance.

4. The method according to claim 1, further comprising:
displaying takeover guidance information in the assisted driving interface, the takeover guidance information indicating to perform a target operation that triggers the vehicle switch from the self-driving state to the manual driving state.

5. The method according to claim 1, further comprising:
displaying operation indication information in the assisted driving interface, the operation indication information indicating a control operation to perform on the vehicle after the vehicle is switched from the self-driving state to the manual driving state.

6. The method according to claim 1, further comprising:
displaying state switching auxiliary information in the assisted driving interface, the state switching auxiliary information including at least one of the state switching point, the distance, or a remaining time for the vehicle to travel to the state switching point based on the self-driving state.

7. The method according to claim 6, wherein:
the state switching auxiliary information includes the distance; and
displaying the state switching auxiliary information in the assisted driving interface includes:
displaying a traveling path of the vehicle in the assisted driving interface; and
displaying, on the traveling path, a target path segment between the location of the vehicle and the state switching point in a style that distinguishes the target path segment from another path segment, other than the target path segment, in the traveling path.

8. The method according to claim 1, further comprising:
displaying, in the assisted driving interface, at least one travelable lane of the vehicle corresponding to a target location in a style that distinguishes the travelable lane from one or more other lanes, other than the at least one travelable lane, in the assisted driving interface, the at least one travelable lane including a lane in which the vehicle currently travels.

9. The method according to claim 1,
wherein the distance threshold is a first distance threshold;
the method further comprising, after outputting the takeover prompt information:
in response to the distance between the location of the vehicle and the state switching point being shorter than a second distance threshold that is shorter than the first distance threshold, outputting, in a strong reminder manner, takeover alarm information, an urgency level of taking over the vehicle corresponding to the takeover alarm information being higher than an urgency level of taking over the vehicle corresponding to the takeover prompt information.

10. The method according to claim 1,
wherein an output manner of the takeover prompt information is a speech output manner;
the method further comprising:
in a process of outputting the takeover prompt information, dynamically adjusting a volume of the takeover prompt information, a value of the volume being negatively correlated with the distance.

11. The method according to claim 1,
when an output manner of the takeover prompt information is a text output manner;
the method further comprising:
in a process of outputting the takeover prompt information, dynamically adjusting a font size of text corresponding to the takeover prompt information, the font size being negatively correlated with the distance.

12. The method according to claim 1, further comprising:
displaying a traveling progress bar of the vehicle in the assisted driving interface; and
identifying a location in the traveling progress bar that corresponds to the state switching point.

13. The method according to claim 1, further comprising, after displaying the navigation map:
displaying an exit control corresponding to the navigation map; and
canceling display of the navigation map in response to a trigger operation on the exit control.

14. The method according to claim 1, further comprising:
displaying a map mode switching control; and
while the navigation map is being displayed, switching a map mode of the navigation map from a first map mode to a second map mode in response to a trigger operation on the map mode switching control.

15. The method according to claim 1, further comprising, after displaying the navigation map:
in response to a switching condition for switching from the manual driving state to the self-driving state being met, displaying state switching prompt information that indicates that switching the manual driving state to the self-driving state is allowed.

16. The method according to claim 1,
wherein the state switching point is a first state switching point;
the method further comprising, after displaying the navigation map:
displaying a second state switching point, the second state switching point being a location on the road at which a switching condition for switching from the manual driving state to the self-driving state is met.

17. The method according to claim 15,
wherein the distance is a first distance and the distance threshold is a first distance threshold;
the method further comprising:
displaying a second distance between the location of the vehicle and the second state switching point; and
displaying, in response to the second distance being shorter than a second distance threshold, a switching control configured for switching from the manual driving state to the self-driving state.

18. An electronic device comprising:
at least one memory storing one or more executable instructions; and
at least one processor configured to execute the one or more executable instructions to:
display an assisted driving interface including self-driving information of a vehicle in response to the vehicle being in a self-driving state;
in response to a distance between a location of the vehicle and a state switching point being shorter than a distance threshold, output takeover prompt information based on the assisted driving interface, the state switching point being a location on a road at which the vehicle is automatically switched from the self-driving state to a manual driving state; and
display a navigation map in response to the vehicle being switched from the self-driving state to the manual driving state.

19. The electronic device according to claim 18, wherein the at least one processor is further configured to execute the one or more executable instructions to:
display a navigation floating layer or a floating window; and
display a navigation route of the vehicle in the navigation floating layer or the floating window.

20. A non-transitory computer-readable storage medium storing one or more computer executable instructions that, when executed by at least one processor, cause the at least one processor to:
display an assisted driving interface including self-driving information of a vehicle in response to the vehicle being in a self-driving state;
in response to a distance between a location of the vehicle and a state switching point being shorter than a distance threshold, output takeover prompt information based on the assisted driving interface, the state switching point being a location on a road at which the vehicle is automatically switched from the self-driving state to a manual driving state; and
display a navigation map in response to the vehicle being switched from the self-driving state to the manual driving state.
